(19) United States
(12) Patent Application Publication
(10) Pub. No.: US 2026/0082225 A1
(43) Pub. Date: Mar. 19, 2026

(54) INFORMATION PROCESSING APPARATUS, CONTROL METHOD, AND STORAGE MEDIUM

(71) Applicant: CANON KABUSHIKI KAISHA, Tokyo (JP)

(72) Inventor: YU KAWAI, Kanagawa (JP)

(21) Appl. No.: 19/322,314

(22) Filed: Sep. 8, 2025

(30) Foreign Application Priority Data
Sep. 13, 2024 (JP) 2024-159083

(51) Int. Cl. H04W 12/06; H04W 76/10

(52) U.S. Cl. CPC H04W 12/068; H04W 76/10

(57) ABSTRACT

A method for controlling an information processing apparatus including a program including a first application program for communicating with a communication apparatus and an operating system includes acquiring, using the first application program, a password of an access point external to the information processing apparatus and the communication apparatus that is managed by a second application program different from the first application program, via a file sharing function of the operating system called by the second application program, and transmitting, using the first application program, connection information including the password acquired via the file sharing function of the operating system to the communication apparatus.

### BACKGROUND

### Field of the Technology

The present disclosure relates to an information processing apparatus, a control method, and a storage medium.

### Description of the Related Art

A configuration is known in which an information processing apparatus such as a smartphone or the like transmits information for connecting to an access point to a communication apparatus such as a printer or the like, whereby the communication apparatus connects to the access point using the information.

Japanese Patent Laid-Open No. 2016-127545 describes a technique in which an information processing apparatus transmits information to a communication apparatus, thereby setting a connection mode for determining a connection method between the information processing apparatus and the communication apparatus in the communication apparatus.

With the prevalence of a method in which information for connecting to an access point is transmitted to a communication apparatus, an improvement in the usability of an application program that executes a process for transmitting information for connecting to an access point to a communication apparatus is requested.

### SUMMARY

The present disclosure is directed to improving the usability of an application program that executes a process for transmitting information for connecting to an access point to a communication apparatus regarding a password.

According to an aspect of the present disclosure, a method for controlling an information processing apparatus including a program including a first application program for communicating with a communication apparatus and an operating system, includes acquiring, using the first application program, a password of an access point external to the information processing apparatus and the communication apparatus that is managed by a second application program different from the first application program, via a file sharing function of the operating system called by the second application program, and transmitting, using the first application program, connection information including the password acquired via the file sharing function of the operating system to the communication apparatus.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a communication system.

FIG. 2 is a diagram illustrating examples of configurations of a terminal apparatus and a communication apparatus.

FIG. 3 is a diagram illustrating an example of a configuration of an application archive.

FIG. 4 is a diagram illustrating an example of a screen for a direct connection.

FIG. 5 is a diagram illustrating an example of a password input screen.

FIGS. 6A and 6B are diagrams each illustrating an example of a screen for confirming a password.

FIG. 7 is a flowchart illustrating an example of processing executed using the first app by the terminal apparatus.

FIG. 8 is a diagram illustrating an example of a confirmation screen.

FIGS. 9A, 9B, 9C, and 9D are diagrams illustrating examples of screens displayed by a password management app of the terminal apparatus.

FIG. 10 is a flowchart illustrating an example of processing executed using a share extension by the terminal apparatus.

FIGS. 11A and 11B are diagrams illustrating examples of screens displayed by the terminal apparatus.

FIG. 12 is a flowchart illustrating an example of processing executed using the first app by the terminal apparatus.

FIGS. 13A and 13B are a flowchart illustrating an example of processing executed using the first app by the terminal apparatus.

FIGS. 14A, 14B, 14C, and 14D are diagrams illustrating examples of screens displayed by the terminal apparatus.

### DESCRIPTION OF THE EMBODIMENTS

### First Embodiment

A description is given of an information processing apparatus and a communication apparatus included in a communication system according to a first embodiment. The information processing apparatus is also referred to as a "terminal apparatus". Although in the present embodiment, a smartphone is illustrated as an example of the information processing apparatus, the present disclosure is not limited to this. As the information processing apparatus, various apparatuses such as a personal computer (PC), a tablet terminal, a personal digital assistant (PDA), a digital camera, and the like are applicable. In the present embodiment, a printer is illustrated as an example of the communication apparatus. The printer may be an inkjet printer that performs printing using ink, or may be a laser beam printer that performs printing using toner. The printer may be a full-color printer capable of color printing, or may be a monochrome printer just capable of monochrome printing. In the present embodiment, the communication apparatus is not limited to a printer. Any apparatus may be applied as the communication apparatus so long as the apparatus can wirelessly communicate with the information processing apparatus. The communication apparatus can be, for example, a copying machine, a facsimile apparatus, a scanner, a smartphone, a laptop PC, a tablet terminal, a PDA, a digital camera, a music reproduction device, a television, a smart speaker, a robotic vacuum cleaner, an automatic cooker, a refrigerator, and the like. The communication apparatus can also be a multifunction peripheral having a plurality of functions such as a copy function, a fax function, a print function, and the like.

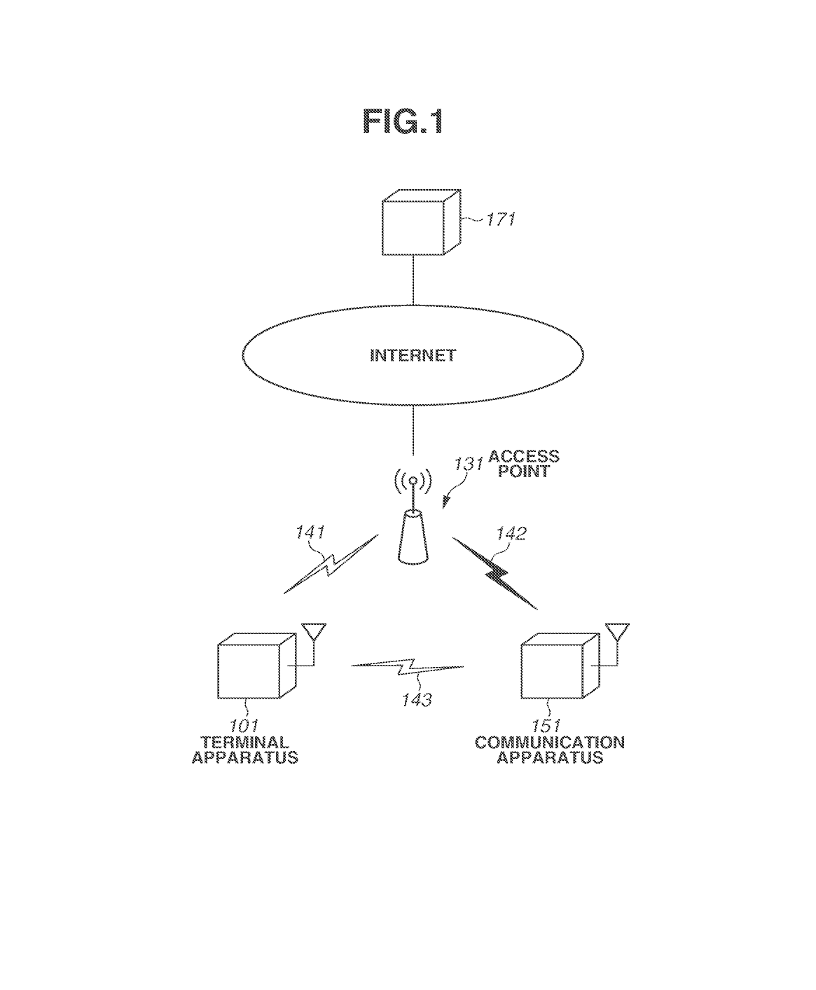

First, a system configuration for achieving the present embodiment will be described. FIG. 1 is a diagram illustrating an example of the configuration of the communication system according to the present embodiment. The communication system includes a communication apparatus 151, a terminal apparatus 101, a terminal apparatus 121, an access point (AP) 131, and an external server 171.

The terminal apparatus 101 is the information processing apparatus according to the present embodiment. The communication apparatus 151 is the communication apparatus according to the present embodiment. The AP 131 is an access point started by an external apparatus present external to the terminal apparatus 101 and the communication apparatus 151. For example, the external apparatus is a local area network (LAN) router. The external server 171 is a server that provides a service via the Internet to an apparatus connected to the AP 131.

In the situation where the communication apparatus 151 and the terminal apparatus 101 are connected to the AP 131, a LAN formed by the AP 131 includes the AP 131, the communication apparatus 151, and the terminal apparatus 101. A wide area network (WAN) includes the AP 131 and the external server 171.

In the present embodiment, if an infrastructure connection is established, the terminal apparatus 101 can communicate with the communication apparatus 151 via the AP 131. If a direct connection is established, the terminal apparatus 101 can communicate directly with the communication apparatus 151 instead of via the AP 131. In the following description, a connection with an AP is equivalent to a connection with a network formed by the AP. A single external apparatus may start a plurality of APs, and the single external apparatus may be able to simultaneously form a plurality of networks.

In the present embodiment, a connection 141 between the terminal apparatus 101 and the AP 131 and a connection 142 between the communication apparatus 151 and the AP 131 are connections using a communication method based on the Institute of Electrical and Electronics Engineers (IEEE) 802.11 series standard. Specifically, the communication method based on the IEEE 802.11 series standard is Wireless Fidelity (Wi-Fi®). A connection 143 between the terminal apparatus 101 and the communication apparatus 151 is also a connection using the communication method based on the IEEE 802.11 series standard. The communication method used for the connection 143 is not limited to this form, and for example, may be Bluetooth® Low Energy, Bluetooth® Classic, Wi-Fi Aware™, near-field communication (NFC), or the like. The AP 131 and the external server 171 can communicate with each other via the Internet, and in the state where the AP 131 is connected to the Internet, an apparatus (the terminal apparatus 101 or the communication apparatus 151) connected to the AP 131 can also use the Internet. The connection 141 between the terminal apparatus 101 and the AP 131 and the connection 142 between the communication apparatus 151 and the AP 131 may be connections using a wired LAN.

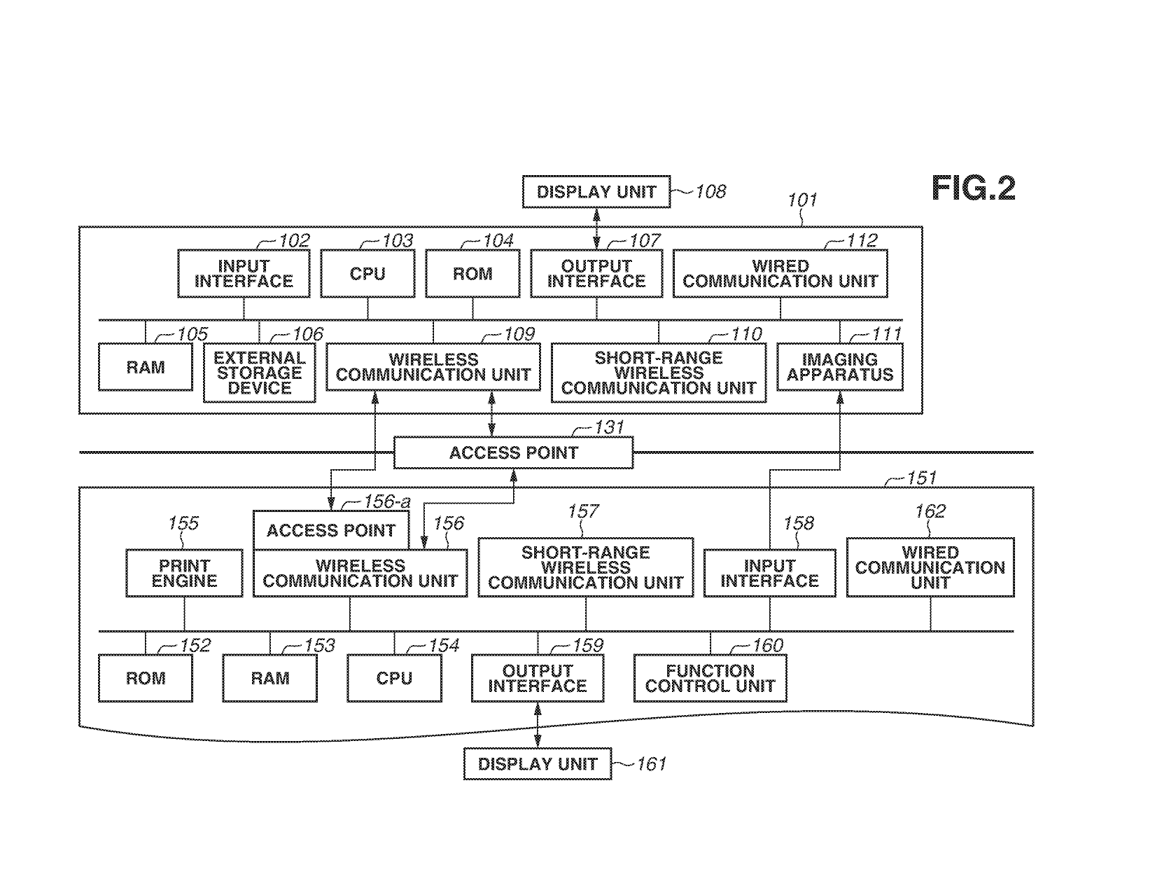

Next, with reference to a block diagram in FIG. 2, a description is given of the configurations of the information processing apparatus according to the present embodiment and the communication apparatus that communicates with the information processing apparatus according to the present embodiment. While the present embodiment is described taking the following configurations as examples, the present embodiment is applicable to an apparatus that communicates with the communication apparatus, and functions are not particularly limited as illustrated in FIG. 2.

The terminal apparatus 101 includes an input interface 102, a central processing unit (CPU) 103, a read-only memory (ROM) 104, a random-access memory (RAM) 105, an external storage device 106, an output interface 107, a display unit 108, a wireless communication unit 109, a short-range wireless communication unit 110, an imaging apparatus 111, a wired communication unit 112, and the like. The CPU 103, the ROM 104, the RAM 105, and the like form a computer of the terminal apparatus 101.

The input interface 102 is an interface for receiving the input of data or an operation instruction from a user and is composed of a physical keyboard, a button, a touch panel, and the like. A configuration may be employed in which the output interface 107 and the input interface 102 are the same component, and the same component outputs a screen and receives an operation from the user.

The CPU 103 is a system control unit and controls the entirety of the terminal apparatus 101. In the present embodiment, the CPU 103 executes control of the display content (display control) of the display unit 108, and the like.

The ROM 104 stores fixed data such as control programs executed by the CPU 103, a data table, an operating system (hereinafter referred to as "OS") program, and the like. In the present embodiment, the control programs stored in the ROM 104 control the execution of software such as scheduling, a task switch, an interrupt process, and the like under control of the embedded OS stored in the ROM 104. In the present embodiment, the ROM 104 stores a predetermined application program (app) for controlling the communication apparatus 151. In other words, an application program is application software. For example, the predetermined app is externally installed on the terminal apparatus 101 by a store app for installing various apps. The predetermined app is an app provided by the vendor of the communication apparatus 151. In the present embodiment, the predetermined app is an app for communicating with the communication apparatus 151 and making a connection setting of the communication apparatus 151. Hereinafter, the predetermined app is referred to as a "first app". The first app may have another function other than the function of making a connection setting of the communication apparatus 151. Specifically, for example, another function is the function of transmitting a print job for causing the communication apparatus 151 to execute printing (a print job transmission function), or the function of transmitting a scan job for causing the communication apparatus 151 to execute scanning (a scan job transmission function). A process described as a process executed by the OS in the present embodiment is a process executed by the CPU 103 according to a program in the OS. Similarly, a process described as a process executed by an app is a process executed by the CPU 103 according to a program in the app.

The RAM 105 is composed of a static random-access memory (SRAM), which requires a backup power supply, or the like. In the RAM 105, data storage is supported by a primary battery for data backup (not illustrated). Thus, the RAM 105 can store important data such as a program control variable or the like without volatilizing the data. A memory area that stores setting information regarding the terminal apparatus 101, management data of the terminal apparatus 101, and the like is provided in the RAM 105. The RAM 105 is also used as a main memory and a work memory for the CPU 103.

The external storage device 106 includes various programs such as a print information generation program for generating print information that can be interpreted by the communication apparatus 151, an information transmission/reception control program for transmitting and receiving information to and from the communication apparatus 151 connected to the terminal apparatus 101 via the wireless communication unit 109, and the like. The external storage device 106 also saves various pieces of information used by these programs and image data obtained from another information processing apparatus or the Internet.

The output interface 107 is an interface that controls the display unit 108 to display data or issue a notification of the state of the terminal apparatus 101.

The display unit 108 includes a light-emitting diode (LED), a liquid crystal display (LCD), or the like. The display unit 108 displays data or issues a notification of the state of the terminal apparatus 101. A software keyboard including keys such as a numerical input key, a mode setting key, a determination key, a cancellation key, a power key, and the like may be provided on the display unit 108, whereby an input from the user may be received via the display unit 108. In the present embodiment, the display unit 108 is a touch panel and can receive an operation using an operator such as a finger, a stylus, or the like from the user.

The wireless communication unit 109 is a component for wirelessly connecting to an apparatus such as the communication apparatus 151, the AP 131, or the like and communicating data with the apparatus. For example, the wireless communication unit 109 may directly communicate with the communication apparatus 151 via wireless communication, or may communicate with the communication apparatus 151 via the AP 131 external to the terminal apparatus 101 or the communication apparatus 151. While in the present embodiment, Wi-Fi®, which is a communication method based on the IEEE 802.11 standard, is used as the wireless communication method of the wireless communication unit 109, Bluetooth® Classic or the like may be used. In the present embodiment, a wireless LAN is a network using Wi-Fi®. In the present embodiment, a connection using a method in which the terminal apparatus 101 and the communication apparatus 151 directly connect to each other without an external AP is referred to as a "direct connection method". A connection using a method in which the terminal apparatus 101 and the communication apparatus 151 connect to each other via an external AP is referred to as an "infrastructure connection method".

The short-range wireless communication unit 110 is a component for communicating data with an apparatus such as the communication apparatus 151 or the like using a short-range wireless communication method and communicates using a communication method different from that of the wireless communication unit 109. The short-range wireless communication unit 110 can connect to a short-range wireless communication unit 157 in the communication apparatus 151. Examples of the communication method of the short-range wireless communication unit 110 include Bluetooth® Low Energy, Bluetooth® Classic, Wi-Fi Aware™, NFC, and the like.

The imaging apparatus 111 is an apparatus that converts an image captured by an imaging element into digital data.

The digital data is temporarily stored in the RAM 105. Then, the digital data is converted into a predetermined image format by a program executed by the CPU 103 and is saved as image data in the external storage device 106.

The wired communication unit 112 is a component for connecting to an apparatus such as the communication apparatus 151, the AP 131, or the like by wire and communicating data with the apparatus. For example, the wired communication unit 112 communicates using the wired LAN. In the present embodiment, the wired LAN communicates based on the Ethernet standard. The present disclosure is not limited to this form, and for example, the wired communication unit 112 may communicate using a Universal Serial Bus (USB) cable. For example, in a case where the terminal apparatus 101 is a smartphone, the terminal apparatus 101 may not include the wired communication unit 112.

The communication apparatus 151 includes a ROM 152, a RAM 153, a CPU 154, a print engine 155, a wireless communication unit 156, a short-range wireless communication unit 157, an input interface 158, an output interface 159, a function control unit 160, a display unit 161, a wired communication unit 162, and the like.

The ROM 152, the RAM 153, the CPU 154, and the like form a computer of the communication apparatus 151.

The wireless communication unit 156 is a component for wirelessly connecting to an apparatus such as the terminal apparatus 101, the AP 131, or the like and communicating data with the apparatus. While in the present embodiment, Wi-Fi® based on the IEEE 802.11 standard is used as the wireless communication method of the wireless communication unit 156, Bluetooth® Classic or the like may be used. The wireless communication unit 156 includes, as an AP internal to the communication apparatus 151, an AP 156-a for connecting to an apparatus such as the terminal apparatus 101 or the like. The AP 156-a can connect to the wireless communication unit 109 of the terminal apparatus 101. The wireless communication unit 156 may directly communicate with the terminal apparatus 101 via the AP 156-a, or may communicate with the terminal apparatus 101 via the AP 131. The AP 156-a may be hardware that functions as an AP, or the wireless communication unit 156 may operate as the AP 156-a by software for functioning as an AP. The communication apparatus 151 may be able to internally start a plurality of APs having different Service Set Identifiers (SSIDs) and passwords.

The RAM 153 is composed of a dynamic random-access memory (DRAM), which requires a backup power supply, or the like. In the RAM 153, data storage is supported by supplying power for data backup (not illustrated) to the RAM 153. Thus, the RAM 153 can store important data such as a program control variable or the like without volatilizing the data. The RAM 153 is also used as a main memory and a work memory for the CPU 154. The RAM 153 saves a reception buffer for temporarily saving print information received from the terminal apparatus 101 or the like, and also saves various pieces of information.

The ROM 152 stores fixed data such as control programs executed by the CPU 154, a data table, an OS program, and the like. In the present embodiment, the control programs stored in the ROM 152 control the execution of software such as scheduling, a task switch, an interrupt process, and the like under control of the embedded OS stored in the ROM 152. A memory area that stores data that also needs to be stored in a case where power is not supplied, such as setting information regarding the communication apparatus 151, management data of the communication apparatus 151, and the like, is also provided in the ROM 152.

The CPU 154 is a system control unit and controls the communication apparatus 151.

Based on information saved in the RAM 153 and a print job received from the terminal apparatus 101, the print engine 155 forms an image on a recording medium such as paper or the like using a recording agent such as ink or the like and outputs the printing result. At this time, the amount of transmitted data of the print job transmitted from the terminal apparatus 101 or the like is large, and therefore, high-speed communication is required. Thus, the communication apparatus 151 receives the print job via the communication unit 156, which can communicate faster than the short-range wireless communication unit 157.

The short-range wireless communication unit 157 is a component for communicating with an apparatus such as the terminal apparatus 101 or the like using a short-range wireless communication method. Examples of the communication method of the short-range wireless communication unit 157 include Bluetooth® Low Energy, Bluetooth® Classic, Wi-Fi Aware™, and the like.

The input interface 158 is an interface for receiving the input of data or an operation instruction from the user and is composed of a physical keyboard, a button, a touch panel, and the like. A configuration may be employed in which the output interface 159 and the input interface 158 are the same component, and the same component outputs a screen and receives an operation from the user. The output interface 159 is an interface that controls the display unit 161 to display data or issue a notification of the state of the communication apparatus 151.

The function control unit 160 manages a functional operation regarding whether to cause the functions of the communication apparatus 151 to simultaneously operate.

The display unit 161 includes an LED, an LCD, or the like. The display unit 161 displays data or issues a notification of the state of the communication apparatus 151. A software keyboard including keys such as a numerical input key, a mode setting key, a determination key, a cancellation key, a power key, and the like may be provided on the display unit 161, whereby an input from the user may be received via the display unit 161.

The wired communication unit 162 is a component for connecting to an apparatus such as the terminal apparatus 101, the AP 131, or the like by wire and communicating data with the apparatus. For example, the wired communication unit 162 communicates using the wired LAN. The present disclosure is not limited to this configuration, and for example, the wired communication unit 162 may communicate using a USB cable.

### Direct Connection Method

A "direct connection" refers to a configuration in which apparatuses wirelessly connect to each other directly (i.e., in a peer-to-peer manner) without an external apparatus such as the AP 131 or the like. A direct connection is also referred to as a "peer-to-peer connection (P2P connection)". The communication apparatus 151 can operate in a mode for communicating via a direct connection (a direct connection mode) as one of connection modes. In Wi-Fi® communication, there is a plurality of modes such as a software AP mode, a Wi-Fi Direct® (WFD) mode, and the like as modes for communicating through a direct connection.

A mode for executing a direct connection using WFD is referred to as a "WFD mode". WFD is a standard formulated by the Wi-Fi® Alliance and is a standard included in the communication standards of the IEEE 802.11 series. In the WFD mode, after a device as a communication partner is found by a search using a device search command, the roles of a P2P group owner (GO) and a P2P client are determined. Then, the remaining wireless connection process is performed. The group owner is equivalent to a Wi-Fi® master station (master apparatus), and the client is equivalent to a Wi-Fi® slave station (slave apparatus). For example, this role determination corresponds to GO negotiation in P2P. In the WFD mode in the state before the role determination is made, the communication apparatus 151 is neither a master station nor a slave station. Specifically, first, one device issues a device search command to a device with which to communicate, thereby searching for a device to which to connect in the WFD mode. If the other device as a communication partner is found by the search, both devices confirm information regarding services and functions that can be supplied by the other devices. This device supply information confirmation is an option and is not essential. For example, this device supply information confirmation phase corresponds to P2P provision discovery. Next, the devices confirm this device supply information with each other and determine which of the devices is to be a P2P client and which of the devices is to be a P2P group owner as their roles. Next, if the client and the group owner are determined, both devices exchange parameters for communicating using WFD with each other. Based on the exchanged parameters, the P2P client and the P2P group owner perform the remaining wireless connection process and an Internet Protocol (IP) connection process. In the WFD mode, the communication apparatus 151 may not execute the GO negotiation, and the communication apparatus 151 may always operate as a GO. That is, the communication apparatus 151 may operate in the WFD mode as autonomous GO mode. For example, the state where the communication apparatus 151 is operating in the WFD mode is the state where a connection using WFD is not established, but the communication apparatus 151 is operating as a GO, or the state where a connection using WFD is established, and the communication apparatus 151 is operating as a GO.

In the software AP mode, between devices (e.g., the terminal apparatus 101 and the communication apparatus 151) that communicate with each other, one device (e.g., the terminal apparatus 101) is a client that serves to request various services. Then, the other device achieves the function of an AP in Wi-Fi® based on the settings of software. The software AP is equivalent to a Wi-Fi® master station, and the client is equivalent to a Wi-Fi® slave station. In the software AP mode, a client searches for a device as a software AP using a device search command. If a software AP is found by the search, the client and the software AP perform the remaining wireless connection process (the establishment of a wireless connection or the like) and then perform an IP connection process (the assignment of IP addresses or the like). As commands and parameters transmitted and received in a case where the client and the software AP achieve a wireless connection, those defined by the Wi-Fi® standard may be used, and the commands and the parameters are not described here.

In the present embodiment, if the communication apparatus 151 establishes and maintains a direct connection, the communication apparatus 151 operates as a master station in a network to which the communication apparatus 151 belongs. The master station is an apparatus that constructs a wireless network and provides a parameter used to connect to the wireless network to a slave station. For example, the parameter used to connect to the wireless network is a parameter regarding a channel used by the master station. The slave station receives the parameter, thereby connecting to the wireless network constructed by the master station, using the channel used by the master station. In the direct connection mode, the communication apparatus 151 operates as the master station, and therefore, the communication apparatus 151 can determine which frequency band is to be used and which channel is to be used for communication in the direct connection mode. In the present embodiment, the communication apparatus 151 can use a channel corresponding to the 2.4 GHz frequency band and a channel corresponding to the 5 GHz frequency band for communication in the direct connection mode.

### Infrastructure Connection Method

An infrastructure connection is a connection method in which devices (e.g., the terminal apparatus 101 and the communication apparatus 151) that communicate with each other connect to an AP (e.g., the AP 131) that performs overall control of a network of the devices, and the devices communicate with each other via the AP. The communication apparatus 151 can also operate in a mode for communicating via an infrastructure connection (an infrastructure connection mode) as one of the connection modes.

In an infrastructure connection, each device searches for an AP using a device search command. If an AP is found by the search, the device and the AP perform the remaining wireless connection process (the establishment of a wireless connection or the like) and then perform an IP connection process (the assignment of IP addresses or the like). As commands and parameters transmitted and received in a case where the device and the AP achieve a wireless connection, those defined by the Wi-Fi® standard may be used, and the commands and the parameters are not described herein.

In the present embodiment, if the communication apparatus 151 operates via an infrastructure connection, the AP 131 operates as a master station, and the communication apparatus 151 operates as a slave station. That is, in the present embodiment, an "infrastructure connection" refers to a connection between the communication apparatus 151 operating as a slave station and an apparatus operating as a master station. If the communication apparatus 151 establishes an infrastructure connection with the AP 131, and the terminal apparatus 101 also establishes an infrastructure connection with the AP 131, the communication apparatus 151 and the terminal apparatus 101 can communicate with each other via the AP 131. A channel to be used for communication via the infrastructure connection is determined by the AP 131, and therefore, the communication apparatus 151 communicates via the infrastructure connection using the channel determined by the AP 131. In the present embodiment, the communication apparatus 151 can use a channel corresponding to the 2.4 GHz frequency band and a channel corresponding to the 5 GHz frequency band for communication through the infrastructure connection. The communication apparatus 151 can also use a channel corresponding to a Dynamic Frequency Selection (DFS) band in the 5 GHz frequency band for communication through the infrastructure connection. To communicate with the communication apparatus 151 via the AP 131, the terminal apparatus 101 recognizes and identifies that the communication apparatus 151 belongs to a network that is formed by the AP 131 and to which the terminal apparatus 101 belongs.

### Connection Setting Process

In the present embodiment, using wireless communication with the communication apparatus 151, the terminal apparatus 101 makes a connection setting (a network connection setting) for causing the communication apparatus 151 to operate in at least one of the infrastructure connection mode or the direct connection mode. The connection setting process in the present embodiment is executed via wireless communication and therefore is also termed "cableless setup (CLS)". The connection setting process may be executed via wired communication. When the first app stored in the external storage device 106 or the like is started, the terminal apparatus 101 performs the connection setting process on the communication apparatus 151. The communication apparatus 151 can operate in a connection setting mode (a connection setting state), which is a mode for executing the connection setting process. The communication apparatus 151 executes the connection setting process in the state where the communication apparatus 151 is operating in the connection setting mode. The details of the connection setting mode will be described below.

To cause the communication apparatus 151 to operate in the infrastructure connection mode, the terminal apparatus 101 wirelessly transmits infrastructure setting information as setting information for causing the communication apparatus 151 to operate in the infrastructure connection mode to the communication apparatus 151. The infrastructure setting information includes information regarding the AP 131. For example, the information regarding the AP 131 is the SSID, the password, information regarding the frequency band, and the like.

To cause the communication apparatus 151 to operate in the direct connection mode, the terminal apparatus 101 wirelessly transmits direct setting information as setting information for causing the communication apparatus 151 to operate in the direct connection mode to the communication apparatus 151. The direct setting information includes an instruction to enable a WFD function and cause the communication apparatus 151 to operate as a group owner, and an instruction to enable an access point setting of the communication apparatus 151. The terminal apparatus 101 acquires connection information required to make a direct connection to the communication apparatus 151 from the communication apparatus 151. The connection information for making a direct connection to the communication apparatus 151 includes information such as the SSID, the password, and the like of the communication apparatus 151 that operates in the direct connection mode.

In the present embodiment, to transmit the infrastructure setting information or the direct setting information or acquire the information for making a direct connection to the communication apparatus 151 in the connection setting process, a direct connection for the connection setting between the terminal apparatus 101 and the communication apparatus 151 is used. Then, in the present embodiment, as the direct connection for the connection setting, a connection using Wi-Fi® is executed. However, for example, a wireless communication standard other than Wi-Fi®, such as Bluetooth® or the like, may be used. A wired communication standard such as the wired LAN, USB, or the like may be used as the direct connection for the connection setting.

After an infrastructure connection or a direct connection using Wi-Fi® is established between the terminal apparatus 101 and the communication apparatus 151 by the connection setting process, the terminal apparatus 101 and the communication apparatus 151 can communicate with each other via the established connection. Specifically, for example, the terminal apparatus 101 can transmit a print job for causing the communication apparatus 151 to execute printing or a scan job for causing the communication apparatus 151 to execute scanning to the communication apparatus 151 through the established connection. While in the present embodiment, it is possible to both cause the communication apparatus 151 to operate in the infrastructure connection mode and cause the communication apparatus 151 to operate in the direct connection mode by the connection setting process, the present disclosure is not limited to this configuration. For example, a configuration may be employed in which it is possible to only cause the communication apparatus 151 to operate in the infrastructure connection mode (i.e., it is not possible to cause the communication apparatus 151 to operate in the direct connection mode) by the connection setting process.

### Connection Setting Mode

The communication apparatus 151 can operate in a connection setting mode. For example, a trigger for the communication apparatus 151 to start operating in the connection setting mode may be the state where the user presses a button for the connection setting mode or the state where the communication apparatus 151 starts (is powered on) for the first time after the arrival of shipment. The button for the connection setting mode may be a hardware button included in the communication apparatus 151, or may be a software button displayed on the display unit 161 by the communication apparatus 151.

If the communication apparatus 151 starts operating in the connection setting mode, the communication apparatus 151 enables both Wi-Fi® communication and Bluetooth® Low Energy communication. Specifically, as the process of enabling Wi-Fi® communication, the communication apparatus 151 enables an AP dedicated to the connection setting mode and internal to the communication apparatus 151 (a connection setting AP). The communication apparatus 151 then enters the state where the communication apparatus 151 can establish a direct connection using Wi-Fi® with the terminal apparatus 101. Connection information (an SSID and a password) for connecting to the connection setting AP is stored in advance in the first app installed on the terminal apparatus 101. That is, the terminal apparatus 101 determines in advance the connection information for connecting to the connection setting AP. Thus, unlike connection information regarding an AP that is enabled in the direct connection mode, the connection information for connecting to the connection setting AP cannot be optionally changed by the user. A method may be employed in which an encryption method is not set for the connection setting AP, and a password is not required to connect to the AP. In the connection setting mode, the communication apparatus 151 may connect to the terminal apparatus 101 using WFD instead of standard Wi-Fi®. That is, the communication apparatus 151 may operate as a group owner and receive a setting command from the terminal apparatus 101 via communication using WFD.

### Registration of Communication Apparatus in App

In the present embodiment, the first app acquires information regarding the communication apparatus 151 from the communication apparatus 151 and thereby can register the communication apparatus 151 in the first app.

For example, the information regarding the communication apparatus 151 is capability information regarding the communication apparatus 151, identification information (a media access control (MAC) address or the like) regarding the communication apparatus 151, model information regarding the communication apparatus 151, or the like. The capability information regarding the communication apparatus 151 includes a list of information regarding functions with which the communication apparatus 151 is compatible, information regarding consumable products (ink and sheets) that can be used in the communication apparatus 151, information indicating the printing method of the communication apparatus 151, and the like. The first app selects a single apparatus as a partner in communication by the first app from among one or more communication apparatuses 151 registered in the first app. Hereinafter, the communication apparatus 151 currently selected as the apparatus as the partner in communication by the first app is referred to as the "communication apparatus 151 that is being selected". The selection of the apparatus as the partner in communication by the first app may be made by receiving from the user the selection of the apparatus from among the one or more communication apparatuses 151 registered in the first app, or may be automatically made based on a predetermined reference by the first app. For example, the apparatus as the partner in communication by the first app may be changed by receiving from the user the selection of the apparatus from among the one or more communication apparatuses 151 registered in the first app. In the present embodiment, the first app transmits various jobs such as a print job, a scan job, and the like to the communication apparatus 151 that is being selected. That is, the communication apparatus 151 that is being selected is an apparatus as the transmission destinations of the various jobs.

### First Issue Solved by Present Embodiment

To connect the communication apparatus 151 to an AP by the connection setting process, the terminal apparatus 101 transmits a password used to connect to the AP to the communication apparatus 151. Then, the communication apparatus 151 connects to the AP using the received password. There is a case where the password transmitted from the terminal apparatus 101 to the communication apparatus 151 in this process is a password input to the terminal apparatus 101 by the user. In this case, the user needs to know a correct password and input the correct password to the terminal apparatus 101. However, conventionally, there is a case where the user does not know a correct (incorrect) password, or the user knows a correct password but inputs an incorrect password, and the incorrect password is input to the terminal apparatus 101. As a result, there is a case where the incorrect password is transmitted to the communication apparatus 151, and the communication apparatus 151 cannot connect to the AP.

In the present embodiment, to solve such an issue, the terminal apparatus 101 executes a process for preventing an incorrect password from being input to the terminal apparatus 101. Specifically, the first app of the terminal apparatus 101 displays a screen presenting a method for confirming a correct password on a screen displayed by a particular app of the terminal apparatus 101. The particular app is an app different from the predetermined app and installed in advance on the terminal apparatus 101 without being installed on the terminal apparatus 101 by the store app. The particular app is a setting app for making various settings of the terminal apparatus 101 and can make various settings including settings regarding a Wi-Fi® connection of the terminal apparatus 101. Hereinafter, a screen for making settings regarding a Wi-Fi® connection of the terminal apparatus 101 from among various settings that can be made by a second app is referred to as a "Wi-Fi® setting screen". Hereinafter, the particular app is referred to as a "second app". The second app can display a list of access points present near the terminal apparatus 101 on the Wi-Fi® setting screen. If a password is required to connect to an access point selected from the list, the second app can receive the input of the password from the user on the Wi-Fi® setting screen.

Then, if the connection using the password is successful, the second app saves and manages various pieces of information regarding the access point to which the terminal apparatus 101 is connected, using the password. Specifically, for example, the various pieces of information are information such as the password, the SSID, the security, and the like. That is, the second app has a management function for saving and managing information regarding an access point to which the terminal apparatus 101 is currently connected, and information regarding an access point to which the terminal apparatus 101 has been connected in the past. In the management function, the second app can display the password of the access point to which the terminal apparatus 101 is currently connected or the password of the access point to which the terminal apparatus 101 has been connected in the past on the Wi-Fi® setting screen. The user confirms the password displayed by the second app and thereby can confirm the correct password of the access point. To display the password by the second app, several operations are required on a screen displayed by the second app. The terminal apparatus 101 includes the second app that differs depending on the OS or the model of the terminal apparatus 101, and therefore, there is a case where an operation for displaying the password by the second app differs depending on the OS or the model of the terminal apparatus 101. If the user does not correctly recognize the operation, the user cannot display the password by the second app. Thus, in the present embodiment, a screen presenting the operation for displaying the password by the second app is displayed.

If the OS of the terminal apparatus 101 is iOS® or iPadOS®, there are a connection that is disconnected based on the transition of the first app to the background (hereinafter, a "first type of connection") and a connection that is not disconnected even if the first app transitions to the background (hereinafter, a "second type of connection") as a connection of the terminal apparatus 101 established according to an instruction from the first app. Specifically, the first type of connection is disconnected by the OS based on the lapse of a predetermined time (e.g., 15 seconds) with the first app remaining in the background after the transition. The second type of connection is maintained without being disconnected by the OS even if the predetermined time elapses with the first app remaining in the background after the transition. Then, as described above, in the present embodiment, the first app displays a screen prompting the user to confirm the password on the Wi-Fi® setting screen displayed by the second app. If the user starts the second app according to the screen, the first app transitions to the background. Then, the following issue arises. In a case where a connection between the communication apparatus 151 operating in the connection setting mode and the terminal apparatus 101 is the first type of connection, and if the user starts the second app and confirms the password, the connection between the communication apparatus 151 operating in the connection setting mode and the terminal apparatus 101 is disconnected. Then, if the connection is disconnected, and even if the user confirms the password on the Wi-Fi® setting screen displayed by the second app and inputs the password to the first app, the first app cannot transmit the input password to the communication apparatus 151. To transmit the input password to the communication apparatus 151, it is necessary to establish the connection again, but an operation for establishing the connection again is necessary, which is cumbersome to the user. Thus, in the present embodiment, control is performed so that a connection between the communication apparatus 151 operating in the connection setting mode and the terminal apparatus 101 is the second type of connection. Consequently, it is possible to perform control so that even if the first app transitions to the background by the user starting the second app, the connection is maintained without being disconnected.

As described above, the first app transmits setting information including the password input to the first app by the user to the communication apparatus 151, thereby establishing a connection between the communication apparatus 151 and an AP. However, there is a case where the user stops trying using a method in which the first app transmits the setting information to the communication apparatus 151 even though the first app displays a password input screen for a reason such as a failure in the confirmation of the password or the like. As the method for establishing a connection between the communication apparatus 151 and another apparatus, a method (another connection method) different from the method in which the first app transmits the setting information to the communication apparatus 151 also exists. However, there is an issue where if the user does not recognize the existence of another connection method or the details of another connection method, the user cannot establish a connection of the communication apparatus 151 by either the method in which the first app transmits the setting information to the communication apparatus 151 or another connection method. Thus, in the present embodiment, a button for displaying a manual regarding another connection method is displayed on the password input screen. Consequently, it is possible to guide the user who stops trying using the method in which the first app transmits the setting information to the communication apparatus 151 even though the first app displays the password input screen, through another connection method. Thus, it is possible to improve usability.

### Password Management App

The terminal apparatus 101 has the iOS® 18 operating system. In the terminal apparatus 101 having iOS® 18, a password management app is provided as standard. The password management app is an app different from the first app and can manage a password. The password can be shared with another app (the first app) in text format by a file sharing function ("sharing action") of the OS.

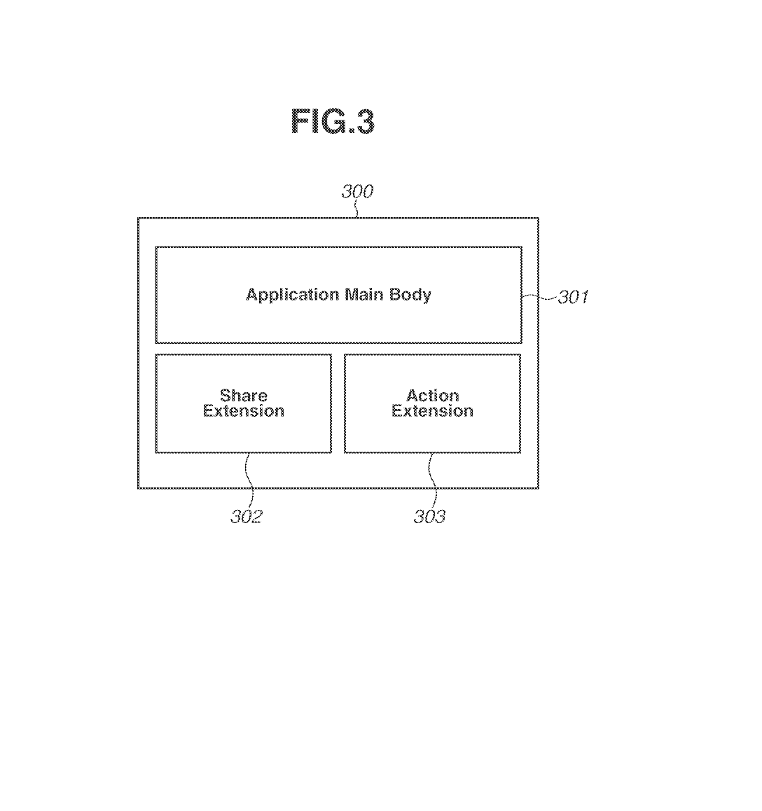

FIG. 3 is a diagram illustrating an example of the configuration of an application archive 300 that is downloaded from an app store by the terminal apparatus 101. The application archive 300 includes an application main body 301, a share extension 302, and an action extension 303. In the present embodiment, the application archive 300 is the first app.

The application main body 301 is an app for communicating with the communication apparatus 151 and is a program that serves the main function of the application archive 300. The share extension 302 and the action extension 303 are programs deemed as application extensions. An application extension refers to an extension program that can operate in the context of the application main body 301.

The application archive 300 is a package program obtained by combining the application main body 301 and the application extensions 302 and 303. The terminal apparatus 101 can download the application archive 300 from the app store.

To receive file sharing by the file sharing function of the OS, the share extension 302 or the action extension 303 is required. In the present embodiment, the file sharing of text data is executed by the share extension 302, and the file sharing of image data is executed by the action extension 303.

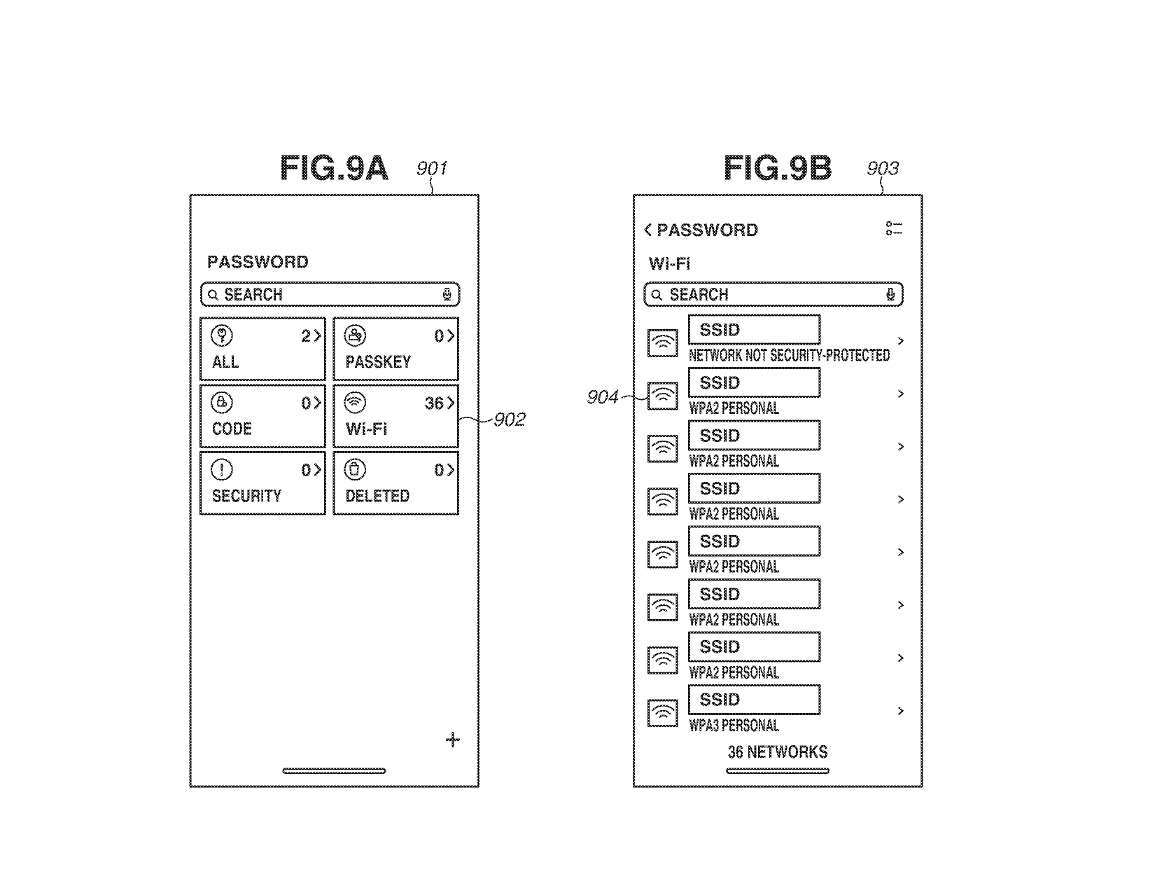

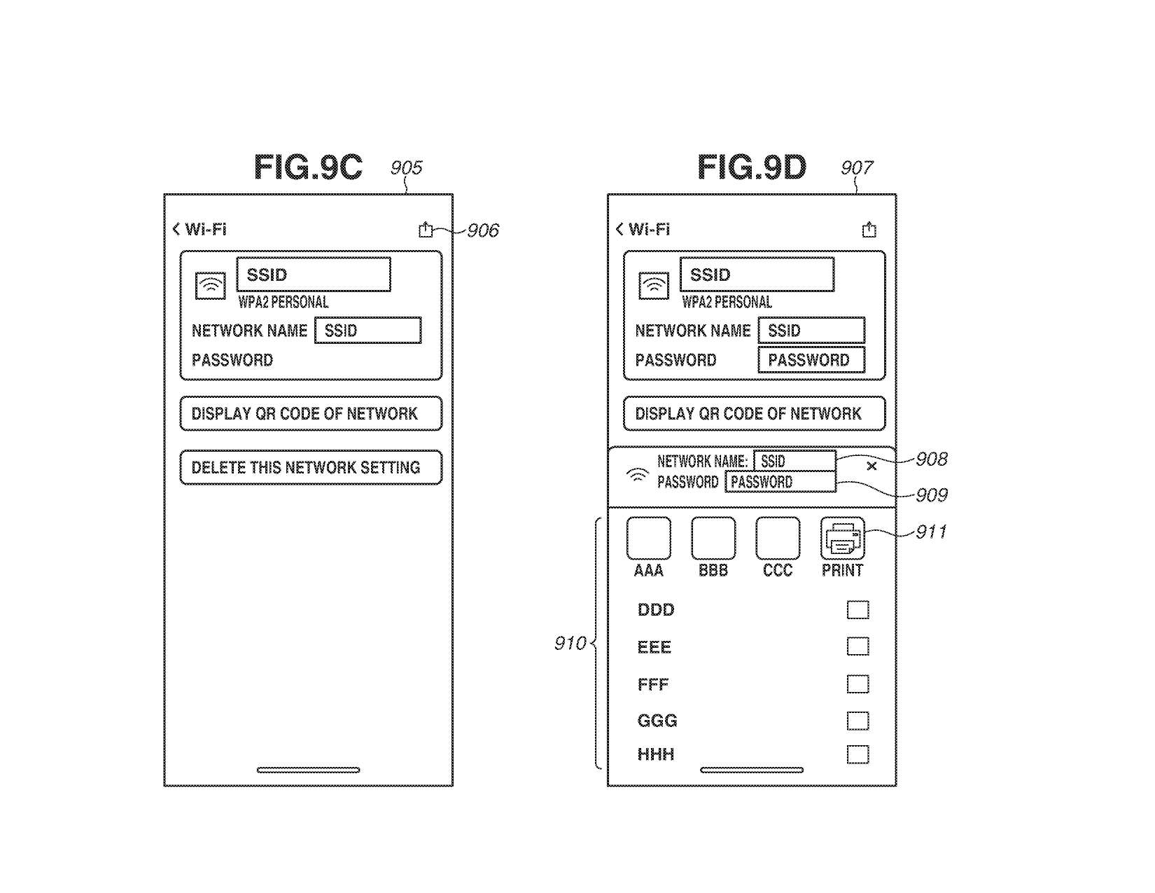

FIGS. 9A to 9D are diagrams illustrating examples of screens 901, 903, 905, and 907 displayed by the password management app of the terminal apparatus 101. A description is provided below of a flow in which the password management app calls the file sharing function of the OS and causes the first app to share a password for Wi-Fi®.

The password management app displays a top screen 901 on the display unit 108. The top screen 901 is a display screen for the password management app. To cause the first app to share the password for Wi-Fi® of the AP 131, the user taps a "Wi-Fi®" button 902 on the top screen 901. The AP 131 is an AP external to both the terminal apparatus 101 and the communication apparatus 151.

As a result, the password management app displays a Wi-Fi® list screen 903 on the display unit 108. The user taps an SSID 904 for Wi-Fi® of the AP 131 on the Wi-Fi® list screen 903.

As a result, the password management app displays a network information screen 905 for the SSID 904 on the display unit 108. The network information screen 905 displays the tapped SSID and the password of the SSID. The user taps a "sharing" button 906 on the network information screen 905.

As a result, the password management app calls the file sharing function of the OS and transmits text data of the SSID and the password to the OS as the sharing target.

As a result, the file sharing function of the OS identifies apps that receive the sharing of text data from among apps installed on the terminal apparatus 101. The share extension 302 of each app declares (presents) which extension corresponds to data in a case where the share extension 302 is compatible with the sharing of the data to the OS.

The password management app displays an action selection screen 907 on the display unit 108. The action selection screen 907 displays an SSID 908 and a password 909 as the sharing target. The OS displays a list 910 of icons corresponding to the identified apps in the action selection screen 907 on the display unit 108. The list 910 is not a user interface (UI) displayed by the password management app, but a UI displayed by the file sharing function of the OS.

The share extension 302 of the first app indicates that the share extension 302 can receive the sharing of text data to the OS. In other words, the share extension 302 of the first app indicates that the share extension 302 is compatible with the sharing of data having an extension corresponding to text data to the OS. Consequently, an icon 911 for the first app is displayed in the list 910. The share extension 302 of the first app may indicate that the share extension 302 is also compatible with the sharing of data having an extension other than an extension corresponding to text data to the OS. Specifically, for example, the share extension 302 of the first app may further indicate that the share extension 302 is compatible with the sharing of data having an extension corresponding to image data or document data to the OS.

The user taps the icon 911 for the first app that the user wishes to cause to share the password for Wi-Fi® of the AP 131 in the list 910. For example, the first app is a print app for performing printing in the communication apparatus 151. As a result, the OS shares text data with the first app corresponding to the icon 911 tapped in the list 910. The text data includes the SSID 908 and the password 909 for Wi-Fi® of the AP 131.

### Processing Executed by Share Extension in Present Embodiment

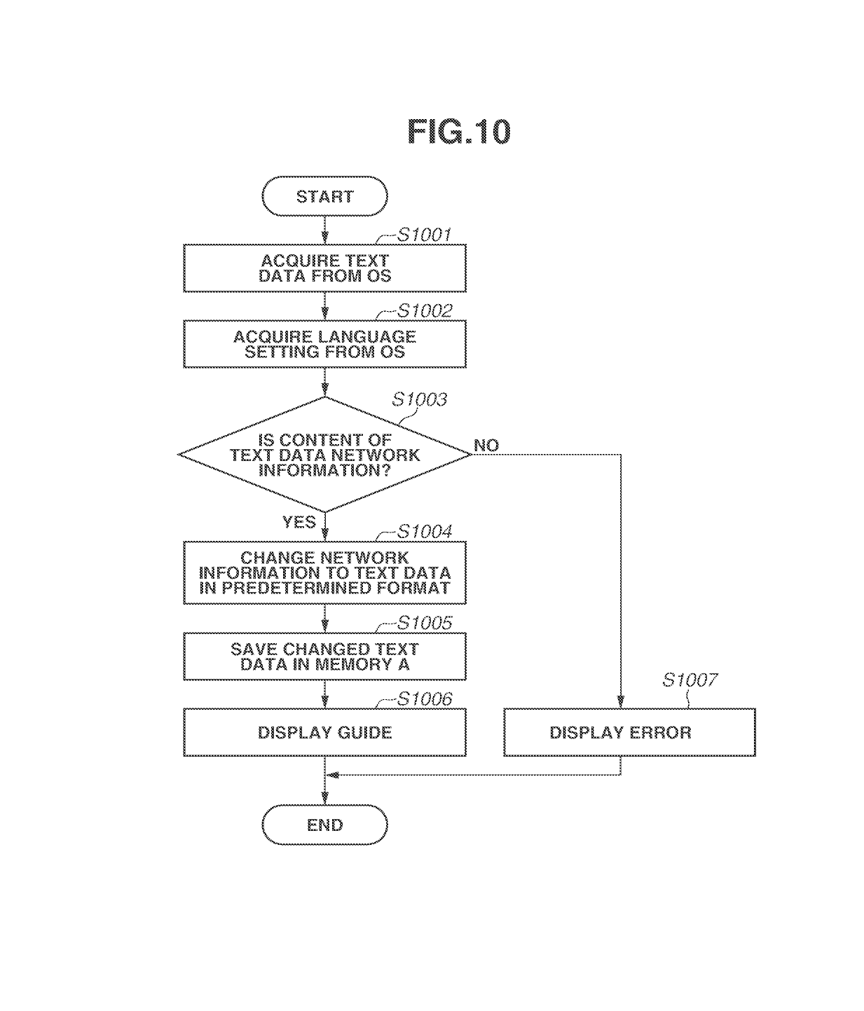

FIG. 10 is a flowchart illustrating an example of processing executed using the share extension 302 by the terminal apparatus 101 in the present embodiment. Processes in the flowchart in FIG. 10 are achieved by, for example, the CPU 103 loading the share extension 302 stored in a memory such as the ROM 104 or the like into the RAM 105 and executing the share extension 302.

If the icon 911 for the first app is tapped in the list 910 in FIG. 9D, the OS instructs the share extension 302 to start, and the share extension 302 starts the processing of the flowchart in FIG. 10.

In step S1001, the share extension 302 acquires text data from the OS via the file sharing function of the OS.

In step S1002, the share extension 302 acquires the language setting of the terminal apparatus 101 from the OS via the file sharing function of the OS.

In step S1003, the share extension 302 determines whether content of the text data acquired in step S1001 is network information. For example, the share extension 302 determines whether the text data (text information) shared via the file sharing function of the OS with the password management app is in a format corresponding to the network information (e.g., an SSID and a password). If it is determined that the text data is in the format corresponding to the network information (YES in step S1003), the processing proceeds to step S1004. If it is determined that the text data is not in the format corresponding to the network information (NO in step S1003), the processing proceeds to step S1007.

Specifically, based on the language setting acquired in step S1002, the share extension 302 determines whether a particular character string is included in the text data.

If the language setting is "Japanese", the text data includes "Japanese character string 1: AAAAA" and "Japanese character string 2: BBBBB". "Japanese character string 1" is a Japanese character string corresponding to "network name" in English. "Japanese character string 2" is a Japanese character string corresponding to "password" in English. "Network name" corresponds to the SSID 908 in FIG. 9D, and "password" corresponds to the password 909 in FIG. 9D. "AAAAA" is data of network name. "BBBBB" is data of password.

If the language setting is "English", the text data includes "Network Name: AAAAA" and "Password: BBBBB".

If the language indicated by the language setting is Japanese, the share extension 302 determines whether character strings "network name" and "password" corresponding to Japanese are included in the text data. If it is determined that the character strings "network name" and "password" are included, the processing proceeds to step S1004. If it is determined that the character strings "network name" and "password" are not included, the processing proceeds to step S1007. The character string "network name" corresponding to Japanese is "Japanese character string 1", and the character string "password " corresponding to Japanese is "Japanese character string 2".

If the language indicated by the language setting is English, the share extension 302 determines whether character strings "network name" and "password" corresponding to English are included in the text data. If it is determined that the character strings "network name" and "password" are included, the processing proceeds to step S1004. If it is determined that the character strings "network name" and "password" are not included, the processing proceeds to step S1007.

In step S1004, the share extension 302 changes the text data to text data in a predetermined format, regardless of the language setting. For example, the text data in the predetermined format is "SSID: AAAAA" and "Password: BBBBB".

That is, in the predetermined format, "AAAAA" indicating content of the network name and "BBBBB" indicating content of the password are maintained as the text data shared via the file sharing function of the OS. Then, in the predetermined format, character strings that are other than "AAAAA" indicating the content of the network name and "BBBBB" indicating the content of the password, and indicate to which data "AAAAA" indicating the content of the network name and "BBBBB" indicating the content of the password correspond are set as character strings identified in advance by the share extension 302. Consequently, in subsequent processing, standardized processing is possible, regardless of the language setting. The character strings identified in advance by the share extension 302 are not limited to the above format, and may be other character strings. The text data after the change may not include the character strings identified in advance by the share extension 302, and may only include "AAAAA" indicating the content of the network name and "BBBBB" indicating the content of the password.

In step S1005, the share extension 302 saves the text data changed in step S1004 in a non-volatile memory A that the first app can access. This text data includes the SSID and the password for Wi-Fi® of the AP 131.

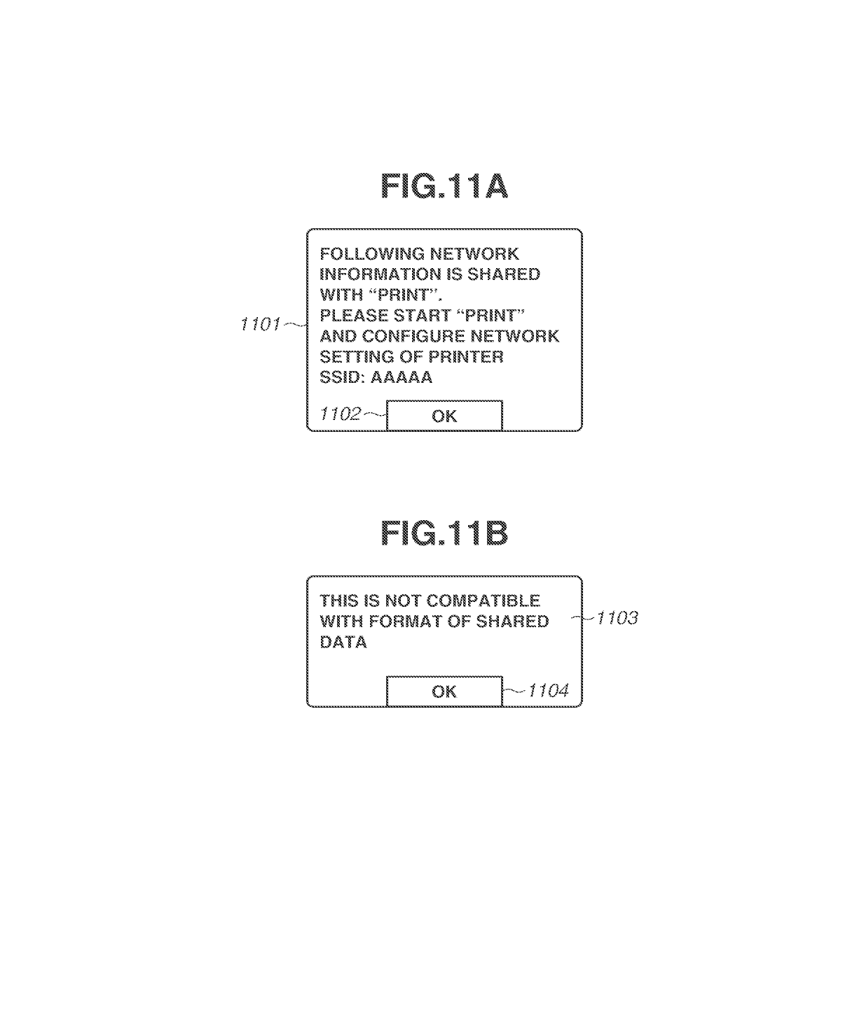

In step S1006, the share extension 302 instructs the OS to display a message 1101 indicating that the sharing of the SSID and the password has been received in FIG. 11A. If an "OK" button 1102 in FIG. 11A is tapped, the processing of the flowchart in FIG. 10 ends.

In step S1007, the share extension 302 instructs the OS to display an error message 1103 in FIG. 11B on the display unit 108. If an "OK" button 1104 in FIG. 11B is tapped, the processing of the flowchart in FIG. 10 ends.

### Processing Executed by First App in Present Embodiment

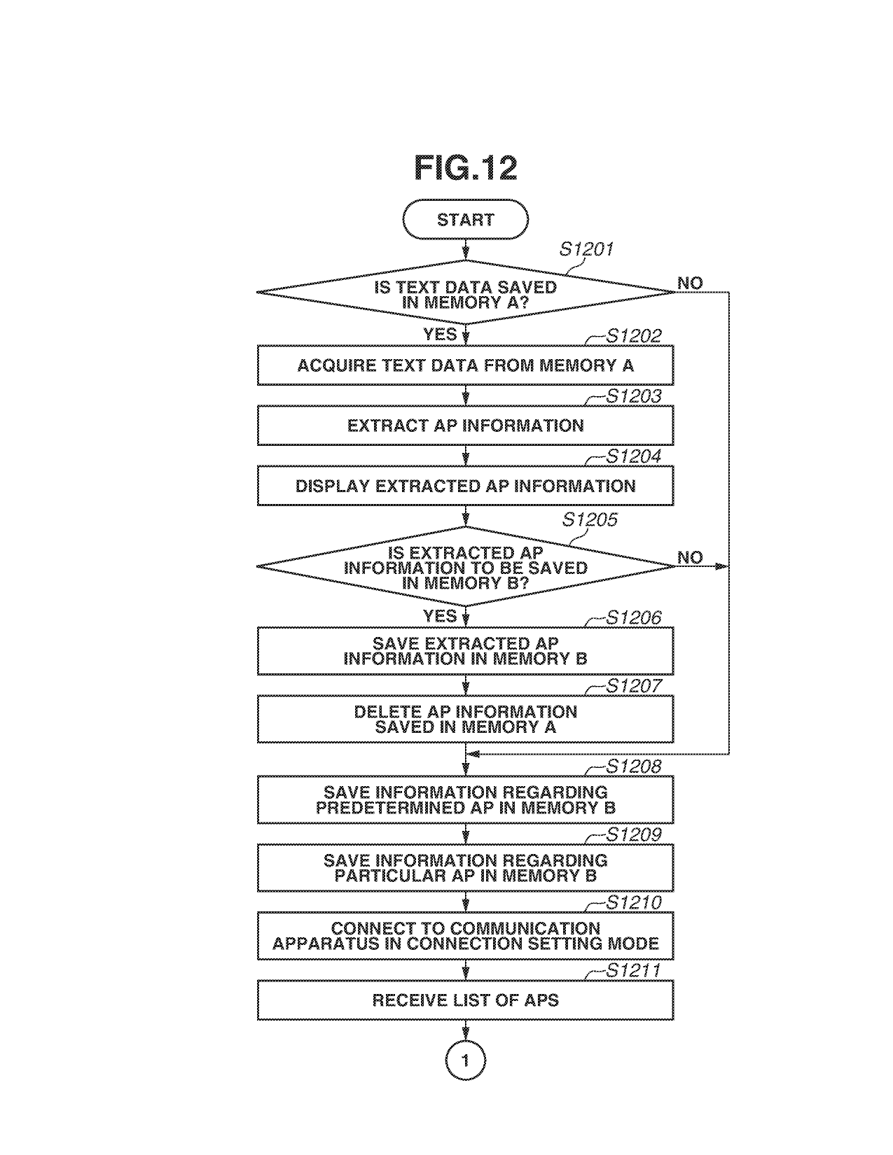

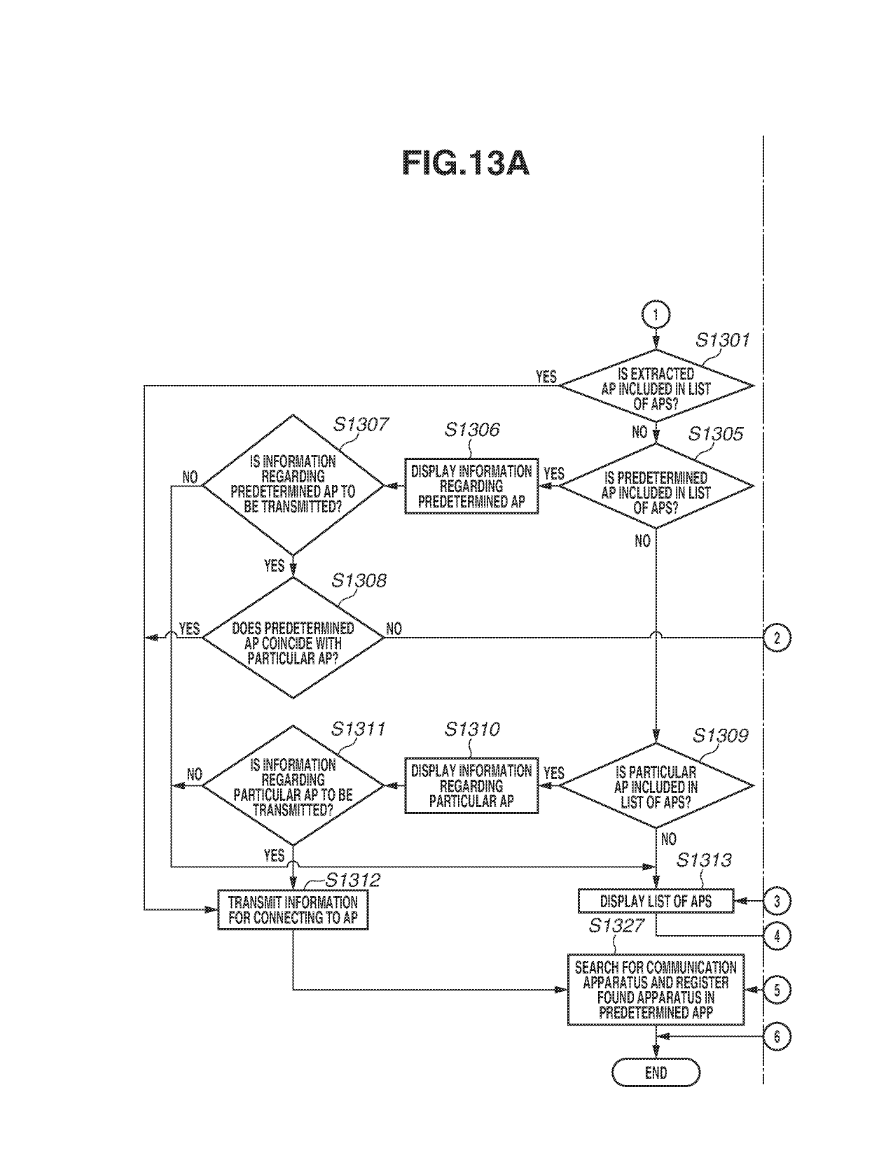

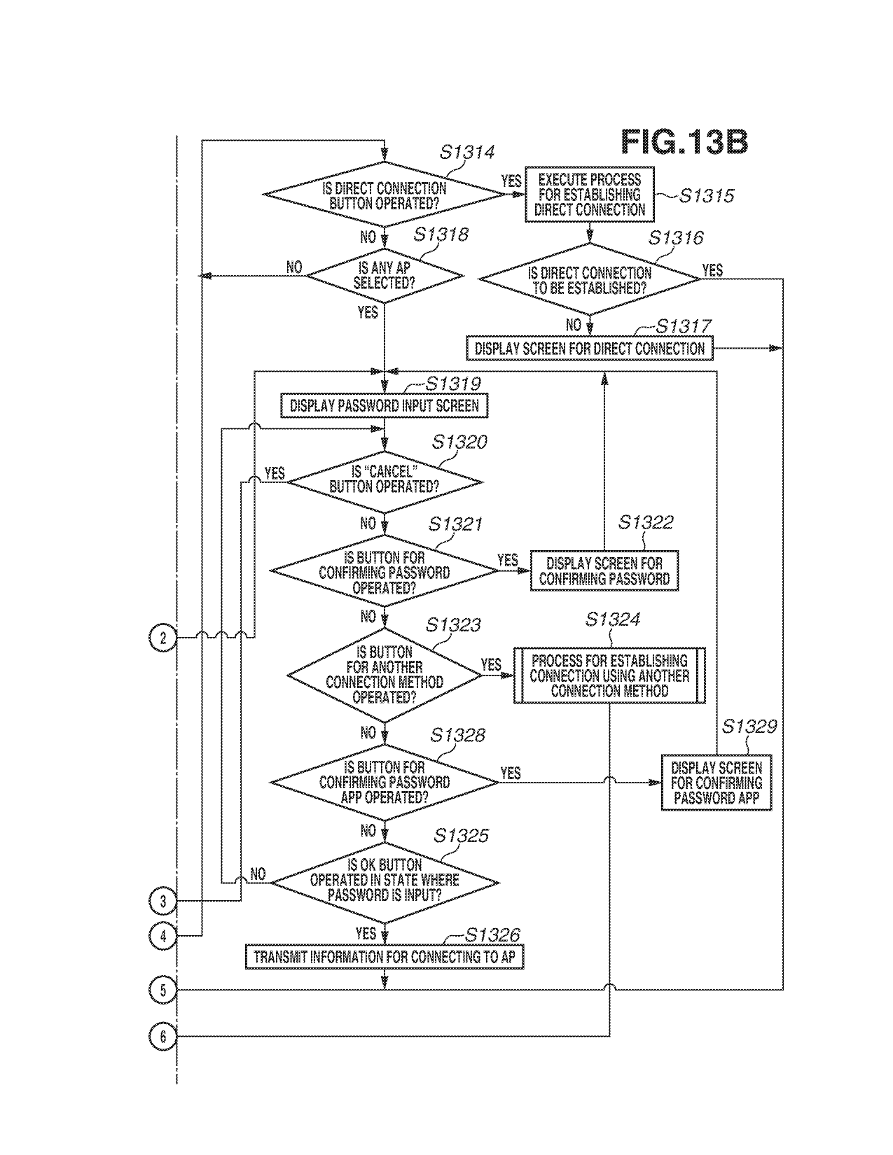

FIGS. 12, 13A, and 13B are flowcharts illustrating examples of processing executed using the first app by the terminal apparatus 101 in the present embodiment. Processes in the flowcharts in FIGS. 12, 13A, and 13B are achieved by, for example, the CPU 103 loading the first app stored in a memory such as the ROM 104 or the like into the RAM 105 and executing the first app. The flowcharts in FIGS. 12, 13A, and 13B are started based on the execution of an operation for executing the connection setting process on a screen displayed by the first app. The flowcharts in FIGS. 12, 13A, and 13B may be started based on the start of the first app. In the present embodiment, the flowcharts in FIGS. 12, 13A, and 13B are executed by the application main body 301 in the first app. The present disclosure, however, is not limited to this approach. The flowcharts in FIGS. 12, 13A, and 13B may be executed by the share extension 302 or the action extension 303. A control method for controlling the terminal apparatus 101 is described below.

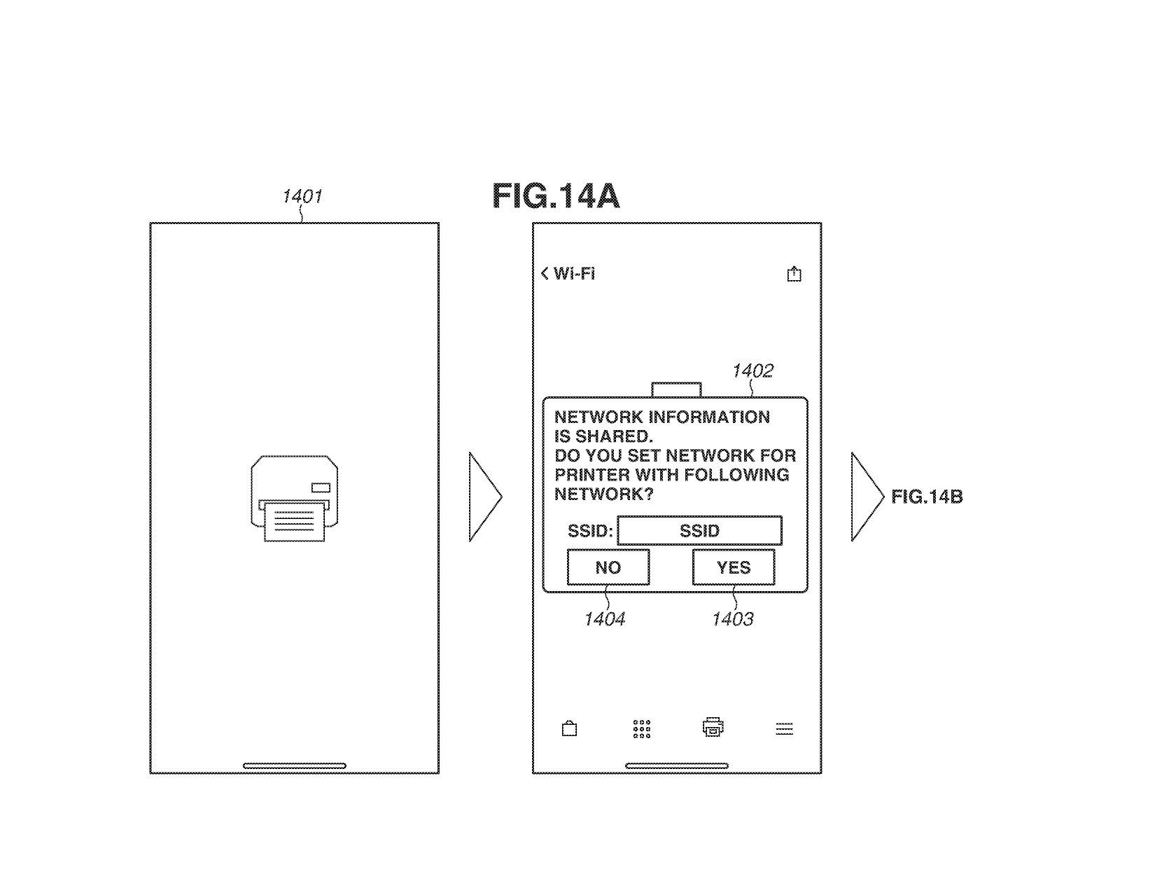

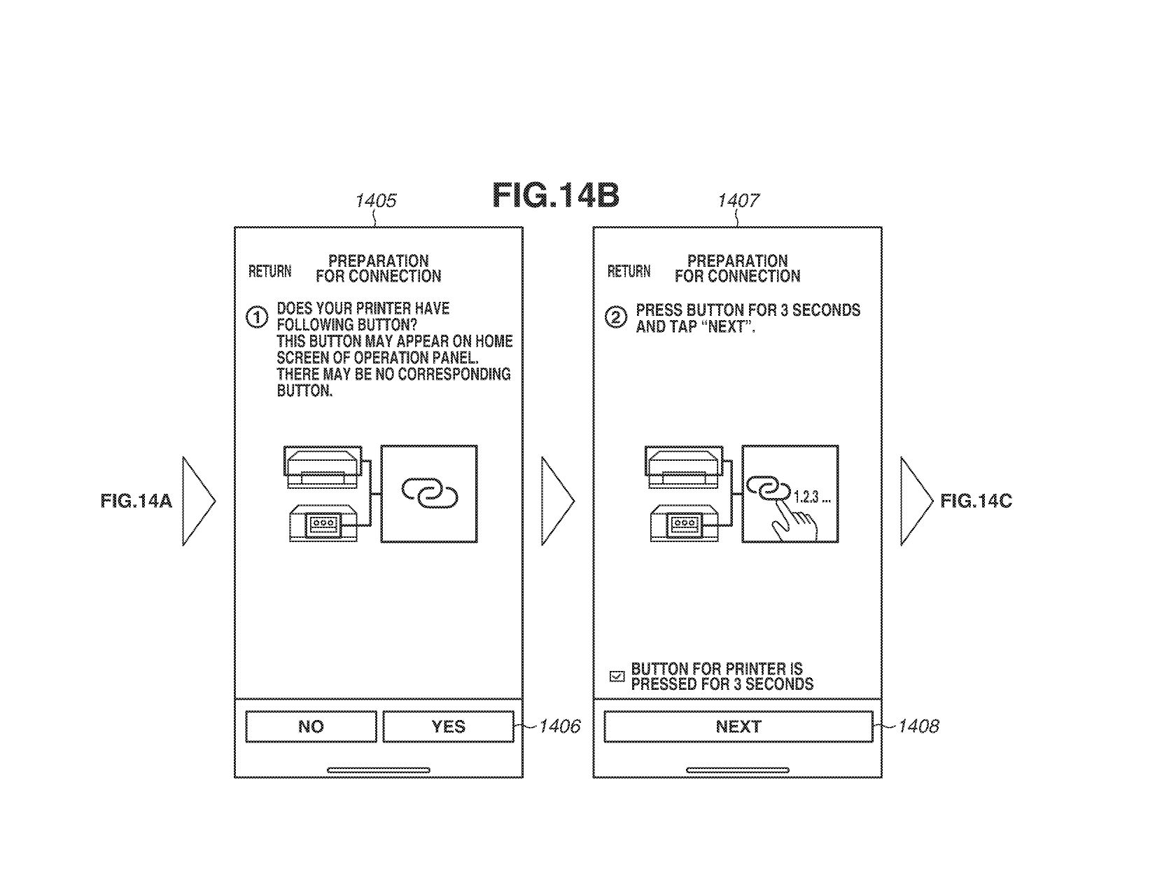

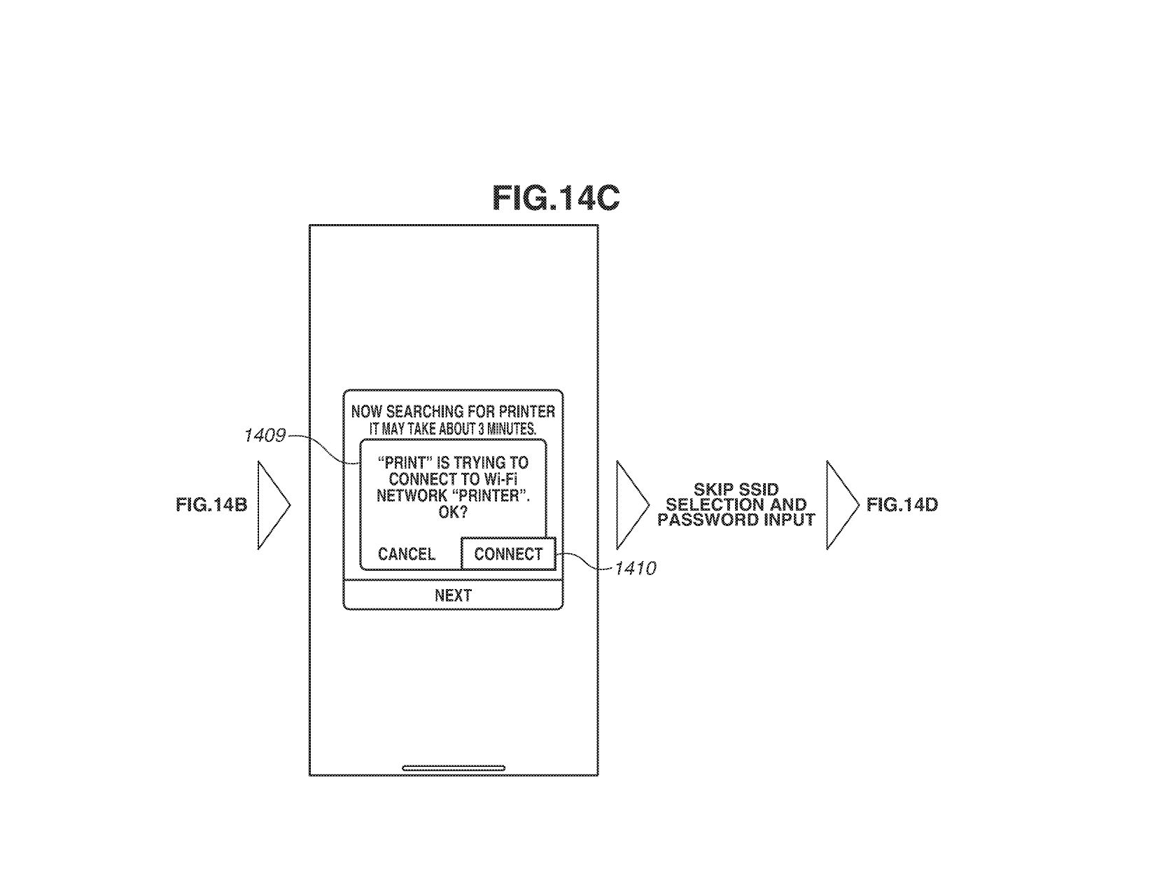

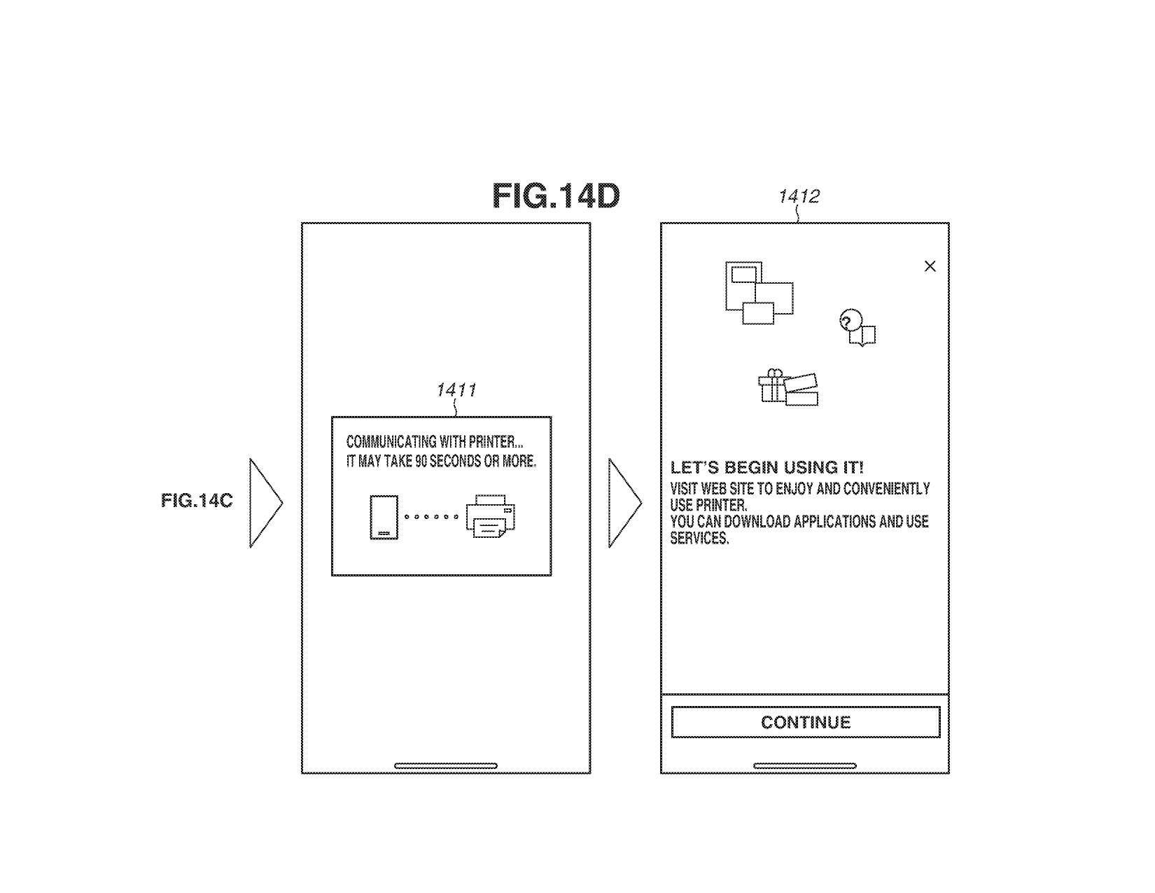

If the user instructs the first app to start, the first app displays a screen 1401 in FIG. 14A on the display unit 108. Then, the processing proceeds to step S1201.

In step S1201, the first app determines whether text data is saved in the memory A that the first app can access. If it is determined that text data is saved (YES in step S1201), the processing proceeds to step S1202. If it is determined that text data is not saved (NO in step S1201), the processing proceeds to step S1208.

In step S1202, the first app acquires the text data from the memory A.

In step S1203, the first app extracts SSID information after "SSID:" and password information after "password:" as AP information from the text data.

In step S1204, as illustrated in FIG. 14A, the first app displays a message 1402 including the extracted AP information. The message 1402 relates to whether to configure a network setting with the extracted AP information, and includes a "YES" button 1403 and a "NO" button 1404.

In step S1205, the first app determines whether to save the extracted AP information in a volatile memory B. Specifically, the first app determines which of the "YES" button 1403 and the "NO" button 1404 is tapped. If it is determined that the "YES" button 1403 is tapped (YES in step S1205), the processing proceeds to step S1206. If the "NO" button 1404 is tapped (NO in step S1205), the processing proceeds to step S1208.

In step S1206, the first app saves the extracted AP information in the volatile memory B.

In step S1207, the first app deletes the text data (including the extracted AP information) saved in the non-volatile memory A.

As described above, the AP information in the text data moves from the non-volatile memory A to the volatile memory B. If this movement is not made, the text data remains in the non-volatile memory A. Thus, every time the first app is started, the processes of steps S1202 to S1207 are performed. If the above movement is made, i.e., if the processes of steps S1202 to S1207 are performed once, the processes of steps S1202 to S1207 do not need to be executed even if the first app is subsequently started.

In step S1208, the first app acquires, from the OS, information regarding an AP to which the terminal apparatus 101 is currently connected using Wi-Fi®. Then, the first app saves the information. In other words, the AP to which the terminal apparatus 101 is currently connected using Wi-Fi® is an AP to which the terminal apparatus 101 is connected when a process as a trigger for the start of the flowchart in FIG. 12 is executed. The process as the trigger for the start of the flowchart in FIG. 12 is the receipt of the operation for executing the connection setting process or the start of the first app. Hereinafter, the AP to which the terminal apparatus 101 is connected using Wi-Fi® at the timing of step S1208 is referred to as a "predetermined AP". The information regarding the AP acquired in this step is information that can be acquired from the OS by the first app from among various pieces of information regarding the AP, and specifically, for example, is the SSID. If the terminal apparatus 101 is not currently connected to an AP using Wi-Fi®, the information regarding the predetermined AP is not acquired.

In step S1209, the first app acquires, from a communication apparatus 151 that is being selected, information regarding an AP to which the communication apparatus 151 that is being selected is currently connected using Wi-Fi®. Then, the first app saves the information. Hereinafter, the AP to which the communication apparatus 151 that is being selected is currently connected using Wi-Fi® is referred to as a "particular AP". The information regarding the particular AP acquired in this step includes the SSID and the password. For example, the information regarding the particular AP is acquired via an infrastructure connection or a direct connection between the terminal apparatus 101 and the communication apparatus 151. If the terminal apparatus 101 cannot currently communicate with the communication apparatus 151 that is being selected, or if the communication apparatus 151 that is being selected is not currently connected to an AP using Wi-Fi®, the information regarding the particular AP is not acquired. The timing when the information regarding the particular AP is acquired is not limited to this timing. For example, based on the start of the first app, the information regarding the particular AP may be acquired at a timing before the flowchart in FIGS. 3A and 3B is started. In this approach, the process of step S1209 is skipped.

In step S1210, the first app displays a screen 1405 in FIG. 14B on the display unit 108. The screen 1405 is a first connection preparation screen for setting the communication apparatus 151 to the connection setting mode. If a "YES" button 1406 on the screen 1405 is tapped, the first app displays a screen 1407 in FIG. 14B on the display unit 108. The screen 1407 is a second connection preparation screen for setting the communication apparatus 151 to the connection setting mode.

If a "next" button 1408 on the screen 1407 is tapped, the first app executes a process for establishing a connection between the communication apparatus 151 operating in the connection setting mode and the terminal apparatus 101. Specifically, the first app instructs the OS to establish a connection between the communication apparatus 151 operating in the connection setting mode and the terminal apparatus 101. More specifically, the first app executes a predetermined application programming interface (API) for establishing a connection of the terminal apparatus 101 while setting at least a partial character string of the SSID of the communication apparatus 151 operating in the connection setting mode as an argument. As a result, the OS searches for an apparatus having an SSID including the character string and displays a connection confirmation message 1409 in FIG. 14C on the display unit 108.

If a "connect" button 1410 in FIG. 14C is tapped, the OS establishes a connection between a found apparatus (i.e., the communication apparatus 151 operating in the connection setting mode) and the terminal apparatus 101. The communication apparatus 151 to which the terminal apparatus 101 connects by this process is a communication apparatus 151 found first by the search executed in the process of step S1210. The present disclosure, however, is not limited to this approach. The first app may display a plurality of communication apparatuses 151 found by the search executed in the process of step S1210 and receive the selection of any of the displayed plurality of communication apparatuses 151 from the user. Then, the communication apparatus 151 to which the terminal apparatus 101 connects by this process may be the communication apparatus 151 selected by the user. While the connection between the communication apparatus 151 operating in the connection setting mode and the terminal apparatus 101 is established, communication between the communication apparatus 151 and the terminal apparatus 101 is executed through this connection.

In the present embodiment, the first app for iOS® performs control so that the connection between the communication apparatus 151 operating in the connection setting mode and the terminal apparatus 101 is the second type of connection. Specifically, in step S1210, the first app for iOS® executes a predetermined API while setting a flag for instructing the OS to establish the second type of connection. Consequently, the OS establishes the connection between the communication apparatus 151 operating in the connection setting mode and the terminal apparatus 101 as the second type of connection. Consequently, even if a predetermined time elapses after the first app operates in the background, the connection between the communication apparatus 151 operating in the connection setting mode and the terminal apparatus 101 is not disconnected.

In step S1211, the first app acquires, from the communication apparatus 151, information regarding a list of APs found by a search executed by the communication apparatus 151. The APs found by the search executed by the communication apparatus 151 are APs to which the communication apparatus 151 can connect. The APs to which the communication apparatus 151 can connect are APs located in the range where the communication apparatus 151 can communicate, and are APs compatible with the capability of the communication apparatus 151. For example, if the communication apparatus 151 can communicate in the 2.4 GHz band, but cannot communicate in the 5 GHz band, the list of APs indicated by the acquired information includes APs compatible with communication in the 2.4 GHz band, but does not include APs compatible with communication in the 5 GHz band. Then, the processing proceeds to step S1301 of FIG. 13A.

In step S1301, the first app determines whether the AP information saved in the volatile memory B in step S1206 is included in the list of APs received in step S1211. If it is determined that the AP information is included (YES in step S1301), the processing proceeds to step S1312. If it is determined that the AP information is not included (NO in step S1301), the processing proceeds to step S1305.

In step S1312, the first app transmits the AP information saved in the volatile memory B in step S1206 to the communication apparatus 151. As described above, this AP information is connection information including the password and the SSID of the AP 131 acquired via the file sharing function of the OS from the password management app. Thus, as illustrated in FIG. 14C, after the "connect" button 1410 is tapped, the first app displays a message 1411 indicating that communication is being performed on the display unit 108 without receiving the selection of the AP 131 and without receiving the input of the password from the user on the password input screen in step S1319. Then, the first app transmits the SSID and the password of the AP 131 to the communication apparatus 151. After the connection information is transmitted to the communication apparatus 151, the communication apparatus 151 ends the connection setting mode and connects to the AP identified as the connection target of the communication apparatus 151 using the received information. The connection setting mode is ended, and as a result, the connection between the communication apparatus 151 and the terminal apparatus 101 is also disconnected. By a reconnection function of the OS, the terminal apparatus 101 connects again to the predetermined AP that is the AP to which the terminal apparatus 101 has been connected before the terminal apparatus 101 has connected to the communication apparatus 151. Then, the processing proceeds to step S1327. The present disclosure is not limited to the method in which the processing proceeds to step S1327. A method may be employed in which the processing proceeds to the process of displaying a screen for searching for a communication apparatus 151 on a Wi-Fi® network to which the terminal apparatus 101 is connected as illustrated in step S710 described below.

In step S1305, the first app determines whether the AP indicated by the information saved in step S1208 (the predetermined AP) is included in the list of APs indicated by the information acquired in step S1211. If the determination is YES (YES in step S1305), the processing proceeds to step S1306. If the determination is NO (NO in step S1305), the processing proceeds to step S1309.

In step S1306, the first app displays the information regarding the predetermined AP and displays a confirmation screen for confirming with the user whether to set a connection target of the communication apparatus 151 to the predetermined AP. The information displayed in this step is the information saved in step S1208, and for example, is the SSID of the predetermined AP.

In step S1307, the first app determines whether to transmit the information regarding the predetermined AP to the communication apparatus 151. In other words, this determination determines whether the user confirms that the connection target of the communication apparatus 151 is set to the predetermined AP. Thus, if an input indicating that the connection target of the communication apparatus 151 is set to the predetermined AP is provided on the confirmation screen, the determination is YES, and the predetermined AP is identified as the connection target of the communication apparatus 151. Then, if an input indicating that the connection target of the communication apparatus 151 is not set to the predetermined AP is provided on the confirmation screen, the determination is NO. If the determination is YES (YES in step S1307), the processing proceeds to step S1308. If the determination is NO (NO in step S1307), the processing proceeds to step S1313.

In step S1308, the first app determines whether the predetermined AP coincides with the particular AP. If the predetermined AP coincides with the particular AP, this means that the first app stores the password of the predetermined AP. Thus, this determination determines whether the first app stores the password of the predetermined AP. In other words, this determination determines whether the password of the predetermined AP is stored in a storage area to which the first app can refer. If the determination is YES (YES in step S1308), the processing proceeds to step S1312. In step S1312, the first app transmits the information regarding the predetermined AP to the communication apparatus 151. If the determination is NO (NO in step S1308), the processing proceeds to step S1319. In step S1319, the first app displays a password input screen.

In step S1308, it may not be determined whether the predetermined AP coincides with the particular AP. The determination made in step S1308 may be the process of determining whether the predetermined AP is an AP corresponding to information stored in the storage area to which the first app can refer. For example, a case where the determination is YES in this method is a case where the password for connecting to the predetermined AP has been input to the first app by the user and transmitted to the communication apparatus 151 in the connection setting process executed in the past by the first app. For example, a case where the determination is NO in this method is a case where the password for connecting to the predetermined AP has not been input to the first app by the user in the connection setting process executed in the past by the first app.

In step S1309 executed if the determination result in step S1305 is NO, the first app determines whether the AP indicated by the information saved in step S1209 (the particular AP) is included in the list of APs indicated by the information acquired in step S1211. If the determination is YES (YES in step S1309), the processing proceeds to step S1310. If the determination is NO (NO in step S1309), the processing proceeds to step S1313.

In step S1310, the first app displays the information regarding the particular AP and displays a confirmation screen for confirming with the user whether to set the connection target of the communication apparatus 151 to the particular AP. The information displayed in this step is the information saved in step S1209, and for example, is the SSID of the particular AP.

In step S1311, the first app determines whether to transmit the information regarding the particular AP to the communication apparatus 151. In other words, this determination determines whether the user confirms that the connection target of the communication apparatus 151 is set to the particular AP. Thus, if an input indicating that the connection target of the communication apparatus 151 is set to the particular AP is provided on the confirmation screen, the determination is YES, and the particular AP is identified as the connection target of the communication apparatus 151. Then, if an input indicating that the connection target of the communication apparatus 151 is not set to the particular AP is provided on the confirmation screen, the determination is NO. If the determination is YES (YES in step S1311), the processing proceeds to step S1312. If the determination is NO (NO in step S1311), the processing proceeds to step S1313.

In step S1312, the first app transmits information for connecting to the AP identified as the connection target of the communication apparatus 151 to the communication apparatus 151. The information transmitted in this step includes the SSID of the AP identified as the connection target of the communication apparatus 151 and the password for connecting to the AP identified as the connection target of the communication apparatus 151. In this process, the AP identified as the connection target of the communication apparatus 151 is the predetermined AP that coincides with the particular AP, or the particular AP. That is, the password transmitted in this step is the password of the particular AP and is the password acquired from the communication apparatus 151 in step S1209. In other words, the password transmitted in this step is the password stored in the first app (the password stored in the storage area to which the first app can refer to). Thus, after the connection target of the communication apparatus 151 is identified, the first app transmits the password to the communication apparatus 151 without receiving the input of the password from the user. After the information for connecting to the AP identified as the connection target of the communication apparatus 151 is transmitted to the communication apparatus 151, the communication apparatus 151 ends the connection setting mode and connects to the AP identified as the connection target of the communication apparatus 151 using the received information. The connection setting mode then ends, whereby the connection between the communication apparatus 151 and the terminal apparatus 101 is also disconnected. Using a reconnection function of the OS, the terminal apparatus 101 re-connects to the predetermined AP that is the AP to which the terminal apparatus 101 has been connected before the terminal apparatus 101 has connected to the communication apparatus 151. Then, the processing proceeds to step S1327. The present disclosure is not limited to the method in which the processing proceeds to step S1327. A method may be employed in which the processing proceeds to the process of displaying a screen for searching for a communication apparatus 151 on a Wi-Fi® network to which the terminal apparatus 101 is connected as in step S710 described below.

If the determination result in step S1307 is NO, or if the determination result in step S1309 is NO, or if the determination result in step S1311 is NO, step S1313 is executed. Then, in step S1313, the first app displays the list of APs indicated by the information acquired in step S1211.

In the present embodiment, a screen including the list includes a direct connection button. If the list does not include an AP desired by the user as the connection target of the communication apparatus 151, the user operates the direct connection button.

In step S1314, the first app determines whether the direct connection button is operated. If the determination is YES (YES in step S1314), the processing proceeds to step S1315. If the determination is NO (NO in step S1314), the processing proceeds to step S1318.

In step S1315, the first app executes a process for establishing a direct connection between the communication apparatus 151 and the terminal apparatus 101. Specifically, first, the first app transmits direct setting information to the communication apparatus 151. Then, the first app acquires connection information for making a direct connection to the communication apparatus 151 from the communication apparatus 151. Then, the first app instructs the OS to establish a connection between the communication apparatus 151 operating in the direct connection mode and the terminal apparatus 101. More specifically, the first app identifies the SSID of the communication apparatus 151 operating in the direct connection mode from the received connection information. Then, the first app executes a predetermined API for establishing a connection of terminal apparatus 101 while setting at least a partial character string of the identified SSID as an argument. As a result, the OS searches for an apparatus having an SSID including the character string and displays a confirmation screen for confirming whether to establish a direct connection between a found apparatus (the communication apparatus 151 operating in the direct connection mode) and the terminal apparatus 101. If the first app is an app for iOS®, then in this process, the first app may execute a predetermined API while setting a flag for instructing the OS to establish a connection that is not disconnected even if the first app transitions to the background. That is, the direct connection between the communication apparatus 151 and the terminal apparatus 101 may be established as the second type of connection. The present disclosure, however, is not limited to this method. In this process, the first app may execute a predetermined API without setting the flag, and the direct connection between the communication apparatus 151 and the terminal apparatus 101 may be established as the first type of connection.

In step S1316, the first app determines whether a user operation indicating that the direct connection is to be established is performed on the confirmation screen displayed by the OS in step S1315. This determination is made by the first app receiving from the OS a notification indicating which operation is performed on the confirmation screen displayed by the OS. If a user operation indicating that the direct connection is to be established is performed, the OS establishes the direct connection. If, however, a user operation indicating that the direct connection is not to be established is performed, the OS does not establish the direct connection. If the determination is YES (YES in step S1316), the processing proceeds to step S1327. If the determination is NO (NO in step S1316), the processing proceeds to step S1317.

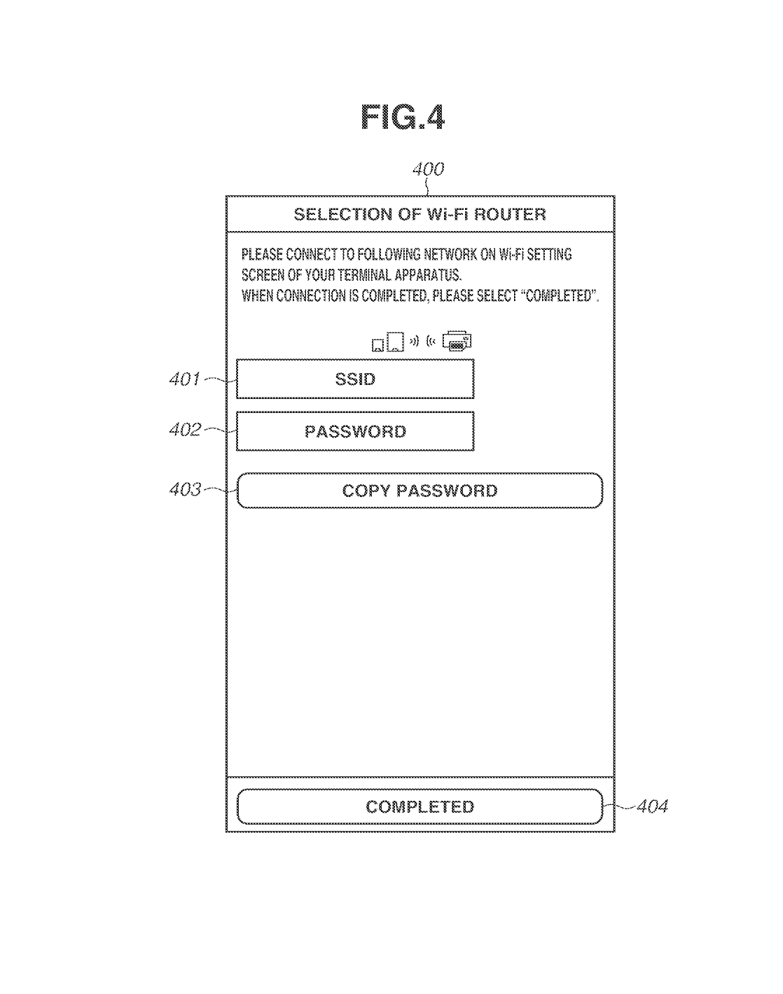

In step S1317, the first app displays a screen for the direct connection. FIG. 4 illustrates an example of the screen displayed in this process. A screen 400 includes an SSID display area 401, a password display area 402, an area 403 for copying the password, and a "completed" button 404. The SSID display area 401 displays the SSID of the communication apparatus 151 operating in the direct connection mode. The password display area 402 displays the password of the communication apparatus 151 operating in the direct connection mode. If the area 403 is operated, the first app copies the password of the communication apparatus 151 operating in the direct connection mode and saves the password in a clipboard of the terminal apparatus 101. The password of the communication apparatus 151 operating in the direct connection mode is copied, whereby the user can easily input the password in the second app and can establish the direct connection using the second app. The screen 400 may include a message prompting the user to establish the direct connection via the Wi-Fi® setting screen displayed by the second app, or a message prompting the user to operate the "completed" button 404 if the establishment of the direct connection is completed. If the "completed" button 404 is operated, the processing proceeds to step S1327. The present disclosure is not limited to the method in which the processing proceeds to step S1327. A method may be employed in which the processing proceeds to the process of displaying a screen for searching for a communication apparatus 151 on a Wi-Fi® network to which the terminal apparatus 101 is connected as in step S710 described below.

In step S1318, which is executed if the determination result in step S1314 is NO, the first app determines whether any AP is selected from the displayed list of APs by the user. If the determination is YES (YES in step S1318), the first app identifies the selected AP as the connection target of the communication apparatus 151, and the processing proceeds to step S1319. If the determination is NO (NO in step S1318), the processing returns to step S1314. In step S1314, the first app waits to receive any operation.

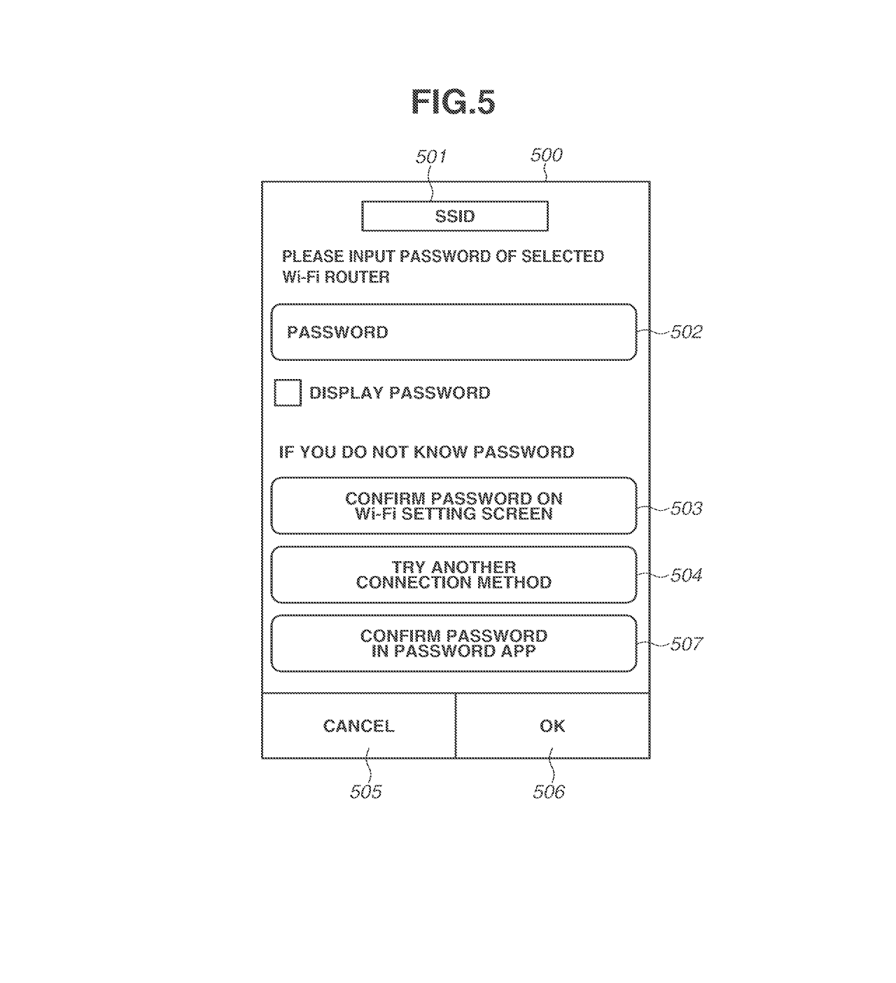

In step S1319, the first app displays a password input screen for receiving the input of the password for connecting to the AP identified as the connection target of the communication apparatus 151 (first display control). The password input screen may be displayed as a pop-up screen on top of the list of APs. FIG. 5 illustrates an example of the screen displayed in this process. A password input screen 500 includes an SSID display area 501, a password input box 502 (a first area), a button 503 for confirming the password, a button 504 for another connection method, a button 507 for confirming the password in the password management app, an "OK" button 506, and a "cancel" button 505. The SSID display area 501 displays the SSID of the AP identified as the connection target of the communication apparatus 151. The password input box 502 is an area that receives the input of the password of the AP identified as the connection target of the communication apparatus 151 from the user. The button 503 for confirming the password is a button regarding the function of displaying the password on the Wi-Fi® setting screen by the second app. The button 504 for another connection method is a button for displaying a manual regarding another connection method. In the present embodiment, "another connection method" refers to a connection method other than a method for establishing a connection between the communication apparatus 151 and another apparatus by the first app transmitting setting information to the communication apparatus 151. In other words, another connection method is a method for establishing a connection between the communication apparatus 151 and another apparatus without the first app transmitting setting information to the communication apparatus 151.

Depending on the version of the OS of the terminal apparatus 101, there is a case where the second app cannot display on the Wi-Fi® setting screen the password of an access point to which the terminal apparatus 101 is currently connected and the password of an access point to which the terminal apparatus 101 has been connected in the past. Specifically, for example, if the OS of the terminal apparatus 101 is a version lower than iOS® 16 or a version lower than iPadOS® 16, the second app cannot display the above passwords on the Wi-Fi® setting screen. Thus, in step S1319, the first app may identify the version of the OS of the terminal apparatus 101 and determine whether the identified version is a version that does not enable the second app to display the above passwords on the Wi-Fi® setting screen. Then, if the result of the determination is YES, the first app may display the password input screen that does not include the button 503 for confirming the password. If the result of the determination is NO, the first app may display the password input screen that includes the button 503 for confirming the password. The password input screen that does not include the button 503 for confirming the password includes other buttons and areas on the screen 500. That is, the button 504 for another connection method is displayed regardless of the version of the OS. For example, in a case where the first app is only compatible with a version of the OS that allows the second app to display the above passwords on the Wi-Fi® setting screen, or the like, the determination of the version and the control for switching the display screen based on the result of the determination of the version may not be executed.

In step S1320, the first app determines whether a user operation on the "cancel" button 505 is received. If the determination is YES (YES in step S1320), the processing proceeds to step S1313. In step S1313, the first app displays the list of APs. If the determination is NO (NO in step S1320), the processing proceeds to step S1321.

In step S1321, the first app determines whether a user operation on the button 503 for confirming the password is received. If the determination is YES (YES in step S1321), the processing proceeds to step S1322. If the determination is NO (NO in step S1321), the processing proceeds to step S1323.

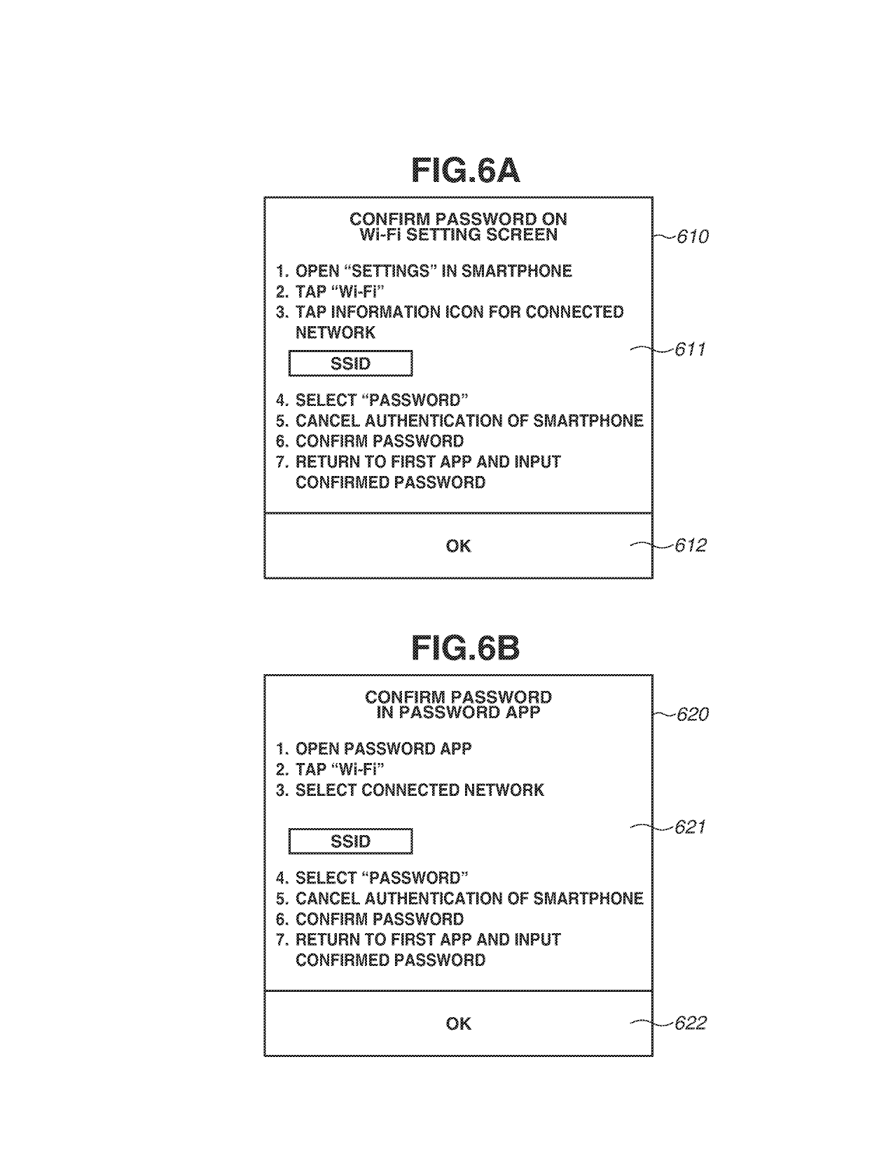

In step S1322, the first app displays a screen for confirming the password. In the present embodiment, the screen for confirming the password is a predetermined screen indicating a method for confirming the password of the AP on the Wi-Fi® setting screen displayed by the second app. FIG. 6A illustrates an example of the screen displayed in this process. In the present embodiment, the screen for confirming the password is not a web page displayed via Internet communication by a web browser. That is, the screen for confirming the password is a screen displayed on the first app based on information stored in advance in the first app. For example, the web browser is an internal browser included in the first app or a browser included in a browser app different from the first app. The present disclosure, however, is not limited to this method. The screen for confirming the password may be a web page displayed by the web browser. The screen for confirming the password may be displayed in a pop-up manner on top of the list of APs.

FIG. 6A illustrates the screen for confirming the password that is displayed in a case where the OS of the terminal apparatus 101 is iOS® or iPadOS® and the first app is an app for iOS® or an app for iPadOS®. A screen 610 includes an area 611 indicating a method for confirming the password of the AP on the Wi-Fi® setting screen displayed by the second app compatible with iOS® or iPadOS® (hereinafter, a "second password confirmation method"), and an "OK" button 612.

The area 611 displays text indicating an operation for confirming the password on the Wi-Fi® setting screen compatible with iOS® or iPadOS® as text indicating the second password confirmation method. The screen 610 may display the SSID of the AP identified as the connection target of the communication apparatus 151. The area 611 may display text prompting the user to return to the first app (cause the first app to transition to the foreground again) after confirming the password. The user who has confirmed the text starts the second app from a home screen of the terminal apparatus 101 or the like and executes the operation indicated by the text, thereby confirming the password. Then, after confirming the password, the user causes the first app to operate in the foreground again, operates the "OK" button 612, and inputs the password on the first app. All terminal apparatuses with iOS® higher than or equal to a predetermined version or iPadOS® higher than or equal to a predetermined version have a function for confirming the password on the Wi-Fi® setting screen.

In step S1323, which is executed if the determination result in step S1321 is NO, the first app determines whether a user operation on the button 504 for another connection method is received. If the determination is YES (YES in step S1323), the processing proceeds to step S1324. If the determination is NO (NO in step S1323), the processing proceeds to step S1325. The details of the process of step S1324 will be described below.

In step S1328, the first app determines whether a user operation on the button 507 for confirming the password in the password management app is received. If the determination is YES (YES in step S1328), the processing proceeds to step S1329. If the determination is NO (NO in step S1328), the processing proceeds to step S1325.

In step S1329, as illustrated in FIG. 6B, the first app displays a screen for confirming the password in the password management app. The screen in FIG. 6B is a predetermined screen indicating a method for confirming the password of the AP that is displayed by the password management app, and is not a web page displayed via Internet communication by a web browser. That is, the screen in FIG. 6B is a screen displayed on the first app based on information stored in advance in the first app. For example, the web browser is an internal browser included in the first app or a browser included in a browser app different from the first app. The present disclosure, however, is not limited to this method. The screen in FIG. 6B may be a web page displayed by the web browser. The screen in FIG. 6B may be displayed as a pop-up on top of the list of APs.

FIG. 6B illustrates the screen for confirming the password in the password management app. A screen 620 includes an area 621 enabling the user to confirm the password of the AP in the password management app, and an "OK" button 622. The area 621 displays text indicating an operation method for confirming the password for Wi-Fi® in the password management app as text indicating a password confirmation method. The password input screen 500 in FIG. 5 may be able to directly display the area 621 in FIG. 6B. The screen 620 may display the SSID of the AP identified as the connection target of the communication apparatus 151. The user who has confirmed the text starts the password management app from a home screen of the terminal apparatus 101 or the like and executes the operation indicated by the text, thereby confirming the password. Then, after confirming the password, the user causes the first app to operate in the foreground again, and operates the "OK" button 622.

As a result, the processing proceeds to step S1319. In step S1319, the user inputs the password on the first app.

In step S1325, the first app determines whether a user operation on the "OK" button 506 is received in the state where the password is input to the password input box 502. Since the user operates the button 503 for confirming the password, the user can input the password to the password input box 502 after confirming the password on the Wi-Fi® setting screen based on the text displayed on the screen illustrated in FIG. 6A. If the password is copied on the Wi-Fi® setting screen and saved in the clipboard, the user can input the password by pasting the saved password to the password input box 502. If the determination is YES (YES in step S1325), the processing proceeds to step S1326. If the determination is NO (NO in step S1325), the processing returns to step S1320. In step S1320, the first app waits to receive any operation on the password input screen 500 from the user.

In step S1326, the first app transmits information for connecting to the AP identified as the connection target of the communication apparatus 151 to the communication apparatus 151. Specifically, the information transmitted in this step includes the password input to the password input box 502 and the SSID of the AP identified as the connection target of the communication apparatus 151. After the information for connecting to the AP identified as the connection target of the communication apparatus 151 is transmitted to the communication apparatus 151, the communication apparatus 151 ends the connection setting mode and connects to the AP identified as the connection target of the communication apparatus 151 using the received information. The connection setting mode ends, and as a result, the connection between the communication apparatus 151 and the terminal apparatus 101 is also disconnected. Using the reconnection function of the OS, the terminal apparatus 101 re-connects to the predetermined AP that is the AP to which the terminal apparatus 101 has been connected before the terminal apparatus 101 has connected to the communication apparatus 151. Then, the processing proceeds to step S1327.

In step S1327, the first app searches for a communication apparatus 151 on a Wi-Fi® network to which the terminal apparatus 101 is connected. For example, if the AP identified as the connection target of the communication apparatus 151 is the predetermined AP, both the communication apparatus 151 and the terminal apparatus 101 connect to the predetermined AP, and therefore, a communication apparatus 151 is found by this search. If the AP identified as the connection target of the communication apparatus 151 is an AP other than the predetermined AP and the communication apparatus 151 connects to the AP other than the predetermined AP, or if the communication apparatus 151 fails in connecting to the AP because the input password is incorrect, a communication apparatus 151 is not found by this search. If a communication apparatus 151 is found by this search, information regarding the communication apparatus 151 is acquired from the communication apparatus 151 via the Wi-Fi® network to which the terminal apparatus 101 is connected, and the communication apparatus 151 is registered in the first app. At this time, the first app may automatically set the newly registered communication apparatus 151 as a communication apparatus 151 that is being selected. Then, the first app displays a registration completed screen 1412 illustrated in FIG. 14D on the display unit 108.

The first app is a connection setting app and is also a print app. The first app can receive the sharing of a file also from an app other than the password management app. Specifically, for example, the first app can receive an image file from an image management app. Then, if an operation for sharing the image file is performed in the image management app targeting the first app, the action extension 303 of the first app starts. Then, the action extension 303 saves the image file in an area that the first app can access. Then, the action extension 303 displays a screen for previewing the image file. Then, if a print instruction is given on the screen, the action extension 303 transmits a print job to the communication apparatus 151. As described above, the application archive 300 can execute the sharing of a password and the sharing of an image file.

The sharing of an image file can also be executed by the share extension 302. Then, the sharing of a password with the password management app can also be executed by the action extension 303. Thus, the sharing of an image file and the sharing of a password may be executed by either the share extension 302 or the action extension 303.

The image management app is an app for managing an image file. Similarly to the password management app, the image management app can share an image file via the file sharing function. The first app can acquire an image file managed by the image management app via the file sharing function of the operating system called by the image management app. In this case, the first app transmits a print job for executing printing based on the image file to the communication apparatus 151 via the AP 131. As a result, the communication apparatus 151 prints the image file based on the print job.

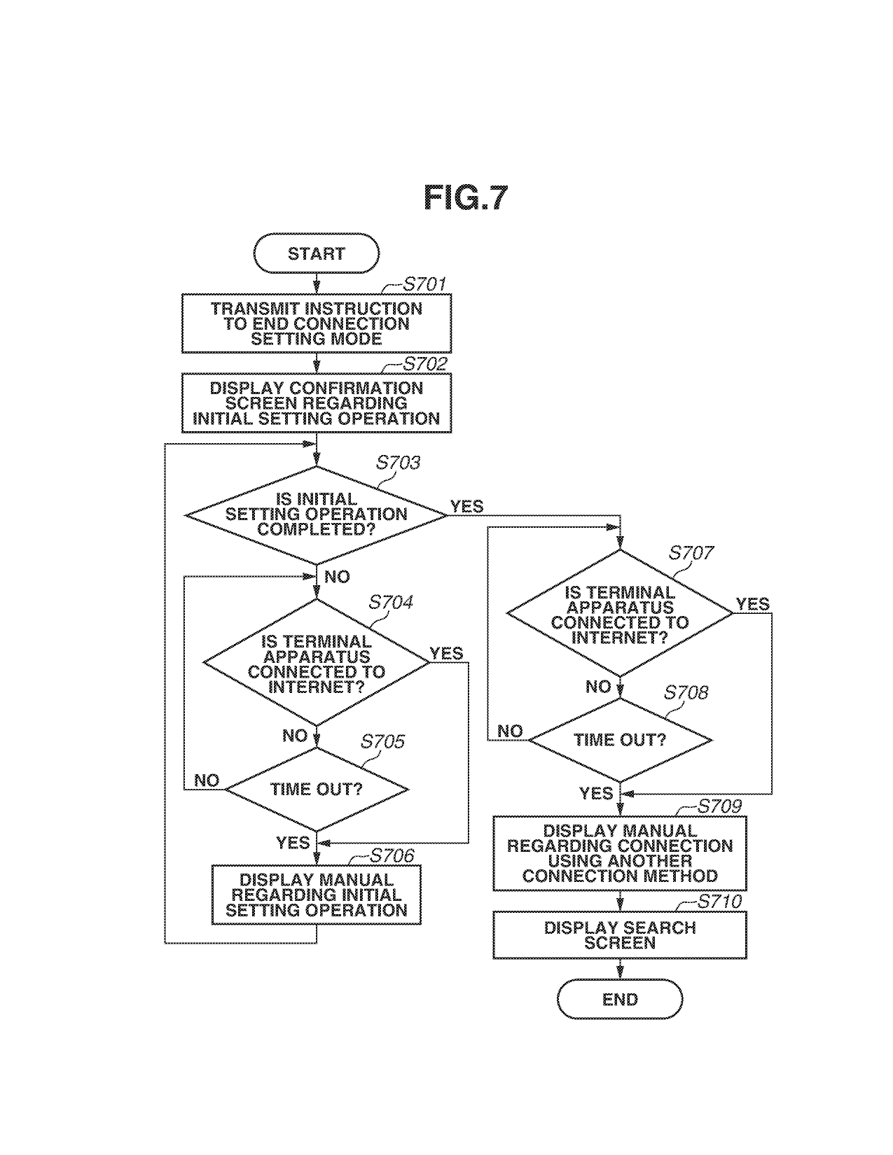

FIG. 7 is a flowchart illustrating an example of processing executed using the first app by the terminal apparatus 101 in the present embodiment. Processes in the flowchart in FIG. 7 are achieved by, for example, the CPU 103 loading the first app stored in a memory such as the ROM 104 or the like into the RAM 105 and executing the first app. The processing of this flowchart corresponds to the process of step S1324.

In step S701, the first app transmits information for instructing the communication apparatus 151 to end the operation in the connection setting mode to the communication apparatus 151. Consequently, the communication apparatus 151 ends the connection setting mode and starts an operation in a mode before the communication apparatus 151 has operated in the connection setting mode again. The connection setting mode ends, and as a result, the connection between the communication apparatus 151 and the terminal apparatus 101 is also disconnected. Using the reconnection function of the OS, the terminal apparatus 101 re-connects to the predetermined AP that is the AP to which the terminal apparatus 101 has connected before the terminal apparatus 101 has connected to the communication apparatus 151.

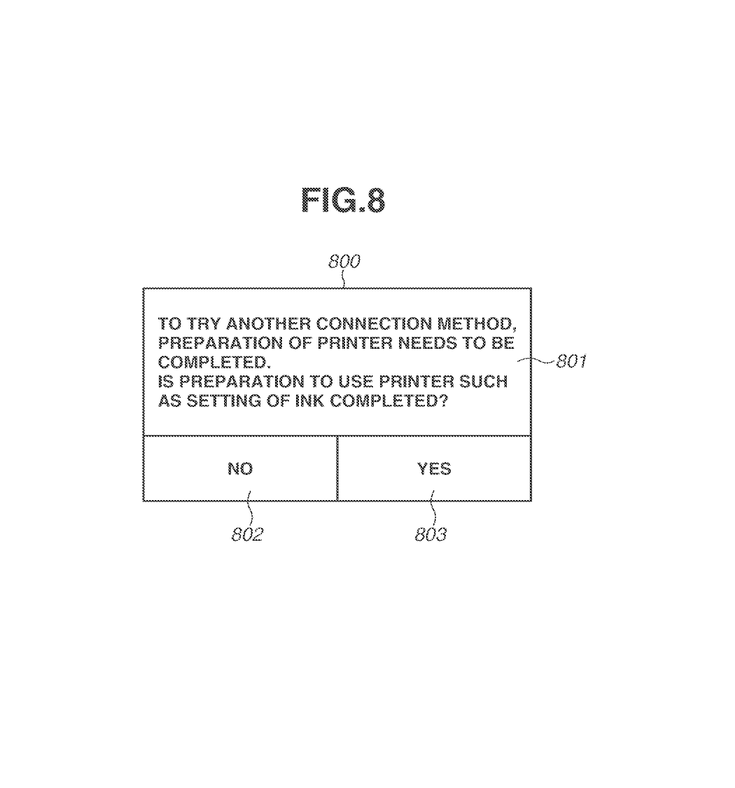

In step S702, the first app displays a confirmation screen for confirming with the user whether an initial setting operation on the communication apparatus 151 is completed. The initial setting operation on the communication apparatus 151 is an operation executed when the communication apparatus 151 is initially powered on (e.g., after delivered). In the present embodiment, for example, the initial setting operation includes the removal of an orange tape from the communication apparatus 151, the attachment of a print head to the communication apparatus 151, the replenishment of a recording material (ink or toner) to the communication apparatus 151, the replenishment of sheets to the communication apparatus 151, the setting of the date and time in the communication apparatus 151, and the like. For example, an initial setting process that is a process executed by the communication apparatus 151 in association with the initial setting operation includes a cleaning process for cleaning the print head, the detection of a sheet, a registration process (registration adjustment process) that is a process for adjusting the landing position of ink on a sheet in printing, the start of an operation in the connection setting mode, and the like. Thus, the confirmation screen is a screen for confirming with the user whether the initial setting process by the communication apparatus 151 is completed. The operations included in the initial setting operation and the processes included in the initial setting process are not limited to this method, and may differ depending on the type of the communication apparatus 151, the printing method, or the like. FIG. 8 illustrates an example of the screen displayed in this process. A screen 800 includes a message 801, a "NO" button 802, and a "YES" button 803. The message 801 includes a message notifying the user that the initial setting operation on the communication apparatus 151 needs to be completed to try another connection method, and a message for confirming whether the initial setting operation on the communication apparatus 151 is completed.

If the initial setting operation on the communication apparatus 151 is completed, the user operates the "YES" button 803. If the initial setting operation on the communication apparatus 151 is not completed, the user operates the "NO" button 802.

In step S703, the first app determines whether a user operation on the "YES" button 803 is received. If a user operation on the "NO" button 802 is received, the result of this determination is NO. If the determination is YES (YES in step S703), the processing proceeds to step S707. If the determination is NO (NO in step S703), the processing proceeds to step S704.

In step S704, the first app determines whether the terminal apparatus 101 is connected to the Internet. As described above, the connection between the communication apparatus 151 and the terminal apparatus 101 is disconnected in step S701, and as a result, the reconnection process by the OS of the terminal apparatus 101 is executed. However, there is a case where an operation on the confirmation screen is performed before the reconnection to the AP using Wi-Fi® is completed. That is, there is a case where an operation on the confirmation screen is performed in the state where the terminal apparatus 101 is not connected to the Internet via the connection using Wi-Fi® with the AP. In this case, a web page cannot be displayed in the process of step S706. This determination is made to correctly display the web page in the process of step S706. In this process, specifically, the first app executes an API for checking whether the terminal apparatus 101 is connected to the Internet. Then, the first app receives from the OS a notification indicating whether the terminal apparatus 101 is connected to the Internet. Then, the first app makes this determination based on content indicated by the received notification. The notification from the OS indicates that the terminal apparatus 101 is connected to the Internet in a case where the terminal apparatus 101 is connected to the Internet through the connection using Wi-Fi® with the AP.

The notification from the OS may also indicate that the terminal apparatus 101 is connected to the Internet in a case where the terminal apparatus 101 is not connected to the Internet via the connection using Wi-Fi® with the AP, but is connected to the Internet via mobile data communication. The process in this determination is not limited to the above method. For example, the first app may execute an API for confirming the SSID of the AP to which the terminal apparatus 101 is currently connected, and receive from the OS a notification indicating the SSID of the AP to which the terminal apparatus 101 is currently connected. Then, if the received notification indicates an SSID different from the SSID of an AP enabled by the communication apparatus 151 operating in the connection setting mode, the determination of the first app may be YES in this determination. If the received notification indicates the SSID of the AP enabled by the communication apparatus 151 operating in the connection setting mode, the determination of the first app may be NO in this determination. That is, this determination may determine whether the terminal apparatus 101 is currently connected to an AP different from the AP enabled by the communication apparatus 151 operating in the connection setting mode. If the received notification indicates the SSID of the predetermined AP, the determination of the first app may be YES in this determination. If the received notification indicates an SSID different from the SSID of the predetermined AP, the determination of the first app may be NO in this determination.

If the determination is YES (YES in step S704), the processing proceeds to step S706. If the determination is NO (NO in step S704), the processing proceeds to step S705.

In step S705, the first app determines whether the time elapsed after the operation on the confirmation screen displayed in step S702 is received exceeds a predetermined threshold. That is, the first app determines whether the time elapsed after the operation on the confirmation screen displayed in step S702 is received times out. For example, the predetermined threshold is 10 seconds. If the determination is YES (YES in step S705), the processing proceeds to step S706. If the determination is NO (NO in step S705), the processing returns to step S704.

In step S706, the first app executes a process for displaying a manual regarding the initial setting operation on the communication apparatus 151. Specifically, the first app displays a web page that displays the manual regarding the initial setting operation on the communication apparatus 151 by the internal browser (an in-app browser) of the first app. Information for displaying the web page is acquired from a predetermined server via the connection to the Internet. Thus, if the communication apparatus 151 is connected to the Internet, the display of the web page is successful. If the communication apparatus 151 is not connected to the Internet, the display of the web page is not successful. Thus, a screen notifying the user that the communication apparatus 151 is not connected to the Internet is displayed by the browser. In the present embodiment, the web page is displayed by the internal browser of the first app, whereby the first app can continue to operate in the foreground. The manual regarding the initial setting operation on the communication apparatus 151 includes content that sequentially explains to the user specific operation methods for the operations to be executed as the initial setting operation on the communication apparatus 151. A method may be employed in which before displaying the web page that displays the manual regarding the initial setting operation on the communication apparatus 151, the first app displays a web page for selecting the model of the communication apparatus 151. Then, if the model is selected on this page, the manual regarding the initial setting operation corresponding to the selected model is displayed. The manual regarding the initial setting operation on the communication apparatus 151 may be displayed not by the internal browser of the first app, but by an external browser of the first app. In this case, the external browser that displays the manual transitions to the foreground, and the first app transitions to the background. The manual regarding the initial setting operation on the communication apparatus 151 may not be displayed as a web page acquired via the Internet, and may be displayed as content included in advance in the first app by the first app without using a browser. A screen displayed by the internal browser of the first app is closed by the user operating a close button on the screen.

A screen displayed by the internal browser of the first app is displayed on the confirmation screen displayed in step S702. Thus, when the screen displayed by the internal browser of the first app is closed, the terminal apparatus 101 can again accept an operation on the confirmation screen. Thus, after this process, the processing returns to step S703.

While in the above description a method has been implemented in which if the determination result in step S705 is YES, the processing proceeds to step S706, the present disclosure is not limited to this method. If the determination result in step S705 is YES, the first app may display a message, on a screen of the first app, notifying the user that the communication apparatus 151 is not connected to the Internet or the like without attempting to display the web page using the browser.

In step S707 executed if the determination result in step S703 is YES, the first app determines whether the terminal apparatus 101 is connected to the Internet. This process is similar to that of step S704. If the determination is YES (YES in step S707), the processing proceeds to step S709. If the determination is NO (NO in step S707), the processing proceeds to step S708.

In step S708, the first app determines whether the time elapsed after the operation on the confirmation screen displayed in step S702 is received exceeds the predetermined threshold. This process is similar to that of step S705. If the determination is YES (YES in step S708), the processing proceeds to step S709. If the determination is NO (NO in step S708), the processing returns to step S707.

In step S709, the first app executes a process for displaying a manual regarding another connection method. Specifically, the first app displays a web page that displays the manual regarding another connection method by the internal browser (the in-app browser) of the first app. Information for displaying the web page is acquired from a predetermined server through the connection to the Internet. Thus, if the communication apparatus 151 is connected to the Internet, the display of the web page is successful. If the communication apparatus 151 is not connected to the Internet, the display of the web page is not successful. Thus, a screen notifying the user that the communication apparatus 151 is not connected to the Internet is displayed by the browser. In the present embodiment, the web page is displayed by the internal browser of the first app, whereby the first app can continue to operate in the foreground. The manual regarding another connection method includes content that explains a specific operation method for establishing a connection between the communication apparatus 151 and an AP using another connection method. Specifically, for example, another connection method includes a method for displaying a list of APs found by a search by the communication apparatus 151 on a screen of the communication apparatus 151 and establishing a connection using Wi-Fi® between an AP selected from the displayed list by the user and the communication apparatus 151. Specifically, for example, another connection method includes a method for establishing a connection using Wi-Fi® between the AP and the communication apparatus 151 based on Wi-Fi Protected Setup™ (WPS). Specifically, for example, another connection method includes a method for establishing a connection using a wired LAN between the AP and the communication apparatus 151 by using a wired LAN cable. A method may be implemented in which before displaying the web page that displays the manual regarding the another connection method on the communication apparatus 151, the first app displays a web page for selecting the model of the communication apparatus 151. Then, if the model is selected on this page, the manual regarding another connection method corresponding to the selected model is displayed. The manual regarding another connection method for the communication apparatus 151 may be displayed not by the internal browser of the first app, but by an external browser of the first app. In this case, the external browser that displays the manual transitions to the foreground, and the first app transitions to the background. The manual regarding another connection method may not be displayed as a web page acquired via the Internet, and may be displayed as content included in advance in the first app by the first app without using a browser.

In step S710, the first app displays a search screen for searching for a communication apparatus 151 on the Wi-Fi® network to which the terminal apparatus 101 is connected. The search screen is displayed underneath the internal browser in the state where the web page is displayed by the internal browser. Thus, if the internal browser is closed by operating a close button, the search screen is displayed. The search screen includes a button for instructing the first app to start searching for a communication apparatus 151 on the Wi-Fi® network to which the terminal apparatus 101 is connected. If this button is pressed, the first app searches for a communication apparatus 151 on the Wi-Fi® network to which the terminal apparatus 101 is connected. Then, the first app displays a list of communication apparatuses 151 found by the search. The first app displays only communication apparatuses 151 compatible with the first app among the plurality of communication apparatuses 151 found by the search. The communication apparatuses 151 compatible with the first app are communication apparatuses 151 provided by the vendor who provides the first app. A method may be employed in which a search is executed using a method for finding only communication apparatuses 151 provided by the vendor of the first app while excluding communication apparatuses 151 provided by another vendor. If any of the communication apparatuses 151 is selected from the displayed list, the first app acquires information regarding the selected communication apparatus 151 from the selected communication apparatus 151 via the Wi-Fi® network to which the terminal apparatus 101 is connected. Then, the first app registers the selected communication apparatus 151 in the first app. Then, the processing of this flowchart ends.

Based on this method, the first app can improve the usability of confirming the password of an AP. The first app can also improve the usability of the confirmation of another connection method.

### Other Embodiments

While the above-described embodiment has discussed a method in which a connection between the communication apparatus 151 operating in the connection setting mode and the terminal apparatus 101 is a connection using Wi-Fi®, the present disclosure is not limited to this method. For example, a connection between the communication apparatus 151 operating in the connection setting mode and the terminal apparatus 101 may be established using a communication method other than Wi-Fi®, such as Bluetooth® Classic, Bluetooth® Low Energy, or the like. In this case, while the connection between the communication apparatus 151 operating in the connection setting mode and the terminal apparatus 101 is also established, the terminal apparatus 101 may maintain a connection using Wi-Fi® with the predetermined AP. That is, in the method in which a connection between the communication apparatus 151 operating in the connection setting mode and the terminal apparatus 101 is a connection using Wi-Fi®, the predetermined AP is an AP to which the terminal apparatus 101 is connected when a process as a trigger for the start of the flowchart in FIGS. 3A and 3B is executed, but the terminal apparatus 101 is not connected when information regarding the predetermined AP is transmitted to the communication apparatus 151. In the method in which a connection between the communication apparatus 151 operating in the connection setting mode and the terminal apparatus 101 is a connection using a communication method other than Wi-Fi®, the predetermined AP is an AP to which the terminal apparatus 101 is connected both when a process as a trigger for the start of the flowchart in FIGS. 3A and 3B is executed and when information regarding the predetermined AP is transmitted to the communication apparatus 151. Thus, the predetermined AP is an AP to which the terminal apparatus 101 is connected at least when a process as a trigger for the start of the flowchart in FIGS. 3A and 3B is executed.

In the above-described embodiment, the process of referring to the particular AP may not be executed. Specifically, for example, the processes of steps S1209 and S1308 to S1312 may be omitted. In this form, if the determination result in step S1305 is NO, step S1313 is executed. If the determination result in step S1307 is YES, step S1319 is executed.

In the above-described embodiment, neither the process of referring to the predetermined AP nor the process of referring to the particular AP needs to be executed. Specifically, for example, the processes of steps S1209, S1208, and S1305 to S1312 may be omitted. In this form, after step S1211, step S1313 is executed.

In the above-described embodiment, the direct connection button may not be displayed on the screen displayed in step S1313. Specifically, for example, the processes of steps S1314 to S1317 may be omitted. In this form, after step S1313, step S1318 is executed.

In the above-described embodiment, even if the version of the OS of the terminal apparatus 101 is a version that enables the second app to display the password on the Wi-Fi® setting screen, the button 503 for confirming the password or the button 504 for another connection method may not be displayed on the password input screen displayed in step S1319. That is, a method may be implemented in which the button 503 for confirming the password or the button 504 for another connection method is displayed while the other is not displayed on the password input screen displayed in step S1319. In the method in which the button 503 for confirming the password is not displayed on the password input screen displayed in step S1319, steps S1321 and S1322 are omitted. If the determination result in step S1320 is NO, step S1323 is executed. In the method in which the button 504 for another connection method is not displayed on the password input screen displayed in step S1319, steps S1323 and S1324 are omitted. If the determination result in step S1321 is NO, step S1325 is executed.

The above-described embodiment discusses a method in which the button 503 for confirming the password is displayed on the password input screen as an area for confirming the password, and if the button 503 is operated, a new screen for confirming the password is displayed. The present disclosure is not limited to this method. As the area for confirming the password, an area indicating text describing a specific password confirmation method may be displayed on the password input screen. That is, the content displayed on the screen for confirming the password in the above-described embodiment may be displayed on the password input screen. Before the password input screen is displayed, this content may be displayed on a screen that is separately and newly displayed. Then, the button 503 for confirming the password may not be displayed on the password input screen 500.

The above-described embodiment discusses a method in which the button 504 for another connection method is displayed on the password input screen as an area for another connection method, and if the button 504 is operated, the screen for another connection method is newly displayed. The present disclosure is not limited to this method. As the area for another connection method, an area indicating text describing another connection method may be displayed on the password input screen. That is, the content displayed on the screen for another connection method in the above-described embodiment may be displayed on the password input screen. Before the password input screen is displayed, this content may be displayed on a screen that is separately and newly displayed. Then, the button 504 for another connection method may not be displayed on the password input screen 500.

In the above-described embodiment, the order of the determinations in steps S1320 to S1325 is not seen to be limiting, and the determinations in steps S1320 to S1325 may be made in any order.

While the above-described embodiment discusses a method in which the list of APs used in the determination in step S1305 or the determination in step S1309 or displayed in step S1313 is a list of APs found by a search executed by the communication apparatus 151, the present disclosure is not limited to this method. The list of APs used in the determination in step S1305 or the determination in step S1309 or displayed in step S1313 may be a list of APs found by a search executed by the terminal apparatus 101. Thus, the process of step S1211 may be omitted.

In the above-described embodiment, the process of referring to information indicating whether the initial setting operation on the communication apparatus 151 is completed may not be executed. Specifically, for example, the processes of steps S702 to S706 may be omitted. Thus, after step S701, step S707 is executed.

The present disclosure is achieved by supplying a storage medium recording a program code of software for achieving the functions of the above-described embodiment(s) to a system or an apparatus. That is, the present disclosure is achieved by a computer (or a CPU or a microprocessor unit (MPU)) of the system or the apparatus reading and executing the program code stored in the storage medium. In this case, the program code itself read from the storage medium achieves the functions of the above-described embodiment(s), and the storage medium storing the program code constitutes the present disclosure.

A flexible disk, a hard disk, an optical disc, a magneto-optical disc, a Compact Disc Read-Only Memory (CD-ROM), a Compact Disc-Recordable (CD-R), a magnetic tape, a non-volatile memory card, a ROM, a Digital Versatile Disc (DVD), or the like can be used as the storage medium for supplying the program code.

The present disclosure covers a case where an OS operating on the computer or the like performs part or all of the actual processing based on an instruction from the program code, where the functions of the above-described embodiment(s) are achieved by the processing.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-159083, filed September 13, 2024, which is hereby incorporated by reference herein in its entirety.

What is claimed is:

1. A method for controlling an information processing apparatus including a program including a first application program for communicating with a communication apparatus and an operating system, the method comprising:
acquiring, using the first application program, a password of an access point external to the information processing apparatus and the communication apparatus that is managed by a second application program different from the first application program, via a file sharing function of the operating system called by the second application program; and
transmitting, using the first application program, connection information including the password acquired via the file sharing function of the operating system to the communication apparatus.

2. The method according to claim 1, further comprising:
executing a determination process for determining whether text information shared from the second application program via the file sharing function is in a format corresponding to the password; and
instructing the operating system to display an error message in a case where a result of the determination process is the text information not being in the format corresponding to the password.

3. The method according to claim 2, wherein the determination process determines whether a specific character string is included in the text information shared from the second application program via the file sharing function.

4. The method according to claim 3, wherein the determination process is executed based on a language setting of the information processing apparatus acquired from the operating system.

5. The method according to claim 4,
wherein, in a case where a language indicated by the language setting is a first language, the determination process determines whether a first character string corresponding to the first language is included in the text information shared from the second application program via the file sharing function, and
wherein, in a case where the language indicated by the language setting is a second language, the determination process determines whether a second character string corresponding to the second language is included in the text information shared from the second application program via the file sharing function.

6. The method according to claim 2, further comprising instructing the operating system to display a message indicating that sharing of the password is accepted in a case where a result of the determination process is the text information being in the format corresponding to the password.

7. The method according to claim 1, further comprising changing text information shared from the second application program via the file sharing function into a predetermined format.

8. The method according to claim 1,
wherein the program includes an application extension, and
wherein acquiring the password via the file sharing function is executed by the application extension.

9. The method according to claim 8, further comprising:
acquiring, by the application extension, data via the file sharing function of the operating system; and
saving a password based on the data in an area accessible to the first application program,
wherein the saved password is acquired by the first application program.

10. The method according to claim 1, further comprising acquiring, by the first application program, a Service Set Identifier (SSID) of the access point via the file sharing function.

11. The method according to claim 1, wherein the first application program transmits the connection information without accepting selection of the access point.

12. The method according to claim 1, further comprising:
displaying, in a case where the first application program does not acquire the password via the file sharing function, a password input screen by the first application program; and
transmitting, by the first application program, connection information including a password input on the password input screen to the communication apparatus.

13. The method according to claim 12, wherein the password input screen is an area for a user to confirm a password in the second application program.

14. The method according to claim 13, wherein the area is an area for displaying an operation method for the user to confirm the password in the second application program.

15. The method according to claim 1, further comprising:
acquiring an image file managed by a third application program via the file sharing function called by the third application program; and
transmitting, in a case where the image file is acquired via the file sharing function, a print job for executing printing based on the image file to the communication apparatus via the access point.

16. The method according to claim 15,
wherein the program includes an application extension, and
wherein acquiring the password and acquiring the image file via the file sharing function are executed by the application extension.

17. The method according to claim 16,
wherein the program includes a share extension and an action extension as the application extension,
wherein acquiring the password via the file sharing function is executed by the share extension, and
wherein acquiring the image file via the file sharing function is executed by the action extension.

18. The method according to claim 16, wherein the communication apparatus is a printer or a scanner.

19. An information processing apparatus including a program including a first application program for communicating with a communication apparatus, and an operating system, the information processing apparatus comprising:
at least one memory and at least one processor which function to:
acquire, using the first application program, a password of an access point external to the information processing apparatus and the communication apparatus that is managed by a second application program different from the first application program, via a file sharing function of the operating system called by the second application program; and
transmit, using the first application program, connection information including the password acquired via the file sharing function of the operating system to the communication apparatus.

20. A non-transitory computer-readable storage medium storing a program, the program including a first application program for communicating with a communication apparatus that causes a computer of an information processing apparatus including an operating system to execute a method, the method comprising:
acquiring, using the first application program, a password of an access point external to the information processing apparatus and the communication apparatus that is managed by a second application program different from the first application program, via a file sharing function of the operating system called by the second application program; and
transmitting, using the first application program, connection information including the password acquired via the file sharing function of the operating system to the communication apparatus.
